(19) United States
(12) Patent Application Publication
(10) Pub. No.: US 2024/0354365 A1
(43) Pub. Date: Oct. 24, 2024

(54) SYSTEM AND METHOD FOR FAST SOLUTION OF PARTIAL DIFFERENTIAL EQUATIONS, BASED ON AN EIGENPERMITTIVITY MODAL APPROACH

(71) Applicant: B.G. NEGEV TECHNOLOGIES AND APPLICATIONS LTD.,ATBEN-GURION UNIVERSITY, Beer Sheva (IL)

(72) Inventors: Yonatan SIVAN, Tel Aviv (IL); Parry YU CHEN, Be?er Sheva (IL)

(21) Appl. No.: 17/612,211

(22) PCT Filed: May 19, 2020
(86) PCT No.: PCT/IL20/50545

§ 371 Date: Nov. 17, 2021

(51) Int. Cl. G06F 17/13

(52) U.S. Cl. CPC G06F 17/13

(57) ABSTRACT

A method for providing fast and efficient solution of partial differential equations to calculate the permittivity modes of an arbitrarily complex scatterer geometry using a modal approach, comprising the steps of defining the background geometry and the scatterer's geometry; embedding each scatterer in a simpler geometry; calculating the base transverse modes for each embedding geometry; for each scatterer, calculating the longitudinal modes; calculating the overlap matrix; solving and the resulting eigenvalue equation, using the base transverse modes that have been calculated for each embedding geometry and the longitudinal modes that have been calculated for the each scatterer; if there is more than one scatterer, hybridizing the modes of each pair of scatterers, otherwise, solving the resulting eigenvalue equation for the complete structure; projecting the source is on target modes; substituting the result is in the final equation.

### FIELD OF THE INVENTION

The present invention relates to the field of mathematical algorithms. More particularly, the present invention relates to a system and method for fast solution of Partial Differential Equations (PDEs) based on an eigenpermittivity modal approach.

### BACKGROUND OF THE INVENTION

Partial differential equations (PDEs) are the main tool for modelling a wide range of physical phenomena, e.g., Maxwell equations for electromagnetic waves, wave equations for acoustic/elastic waves etc., heat equations, Navier-Stokes equations for fluid dynamics etc. As analytic solutions are available only for selected simple scenarios, developing efficient numerical techniques for PDE solution is a main effort in mathematics research.

Commercial software for solving PDEs became abundant over the last two decades. However, it provides an efficient solution of PDEs underlying the relevant physical scenario.

Numerical solutions of such PDEs are based on discretizing space into small elements (e.g., finite elements/differences methods), such that each elements encodes information on the relevant material properties. This procedure converts the PDE into a (large) set of coupled algebraic linear equations, of the form A̅x=b, where A is the matrix representing the physics and geometry (Maxwell equations, heat equation etc.), x is a vector representing the solution (electromagnetic field amplitudes, temperature distribution etc.), and b is the source vector (the incident electromagnetic field or heat source etc.). Such problems with a predefined source are being referred as scattering problems.

Traditionally, the resulting scattering problems are solved by matrix inversion, x=A̅⁻¹b or variations of this approach (e.g., conjugate gradient methods [1] etc.). Even though there are methods for doing that, there are situations where the traditional procedures suffer from difficulties (in accuracy, e.g., due to geometric singularities [2] etc.), in particular for matrices with a large condition number [3]. In addition, whenever any change is made to the configuration (source, geometry etc.), the solution procedure has to be repeated. This poses a major limitation on computationally intense problems (e.g., involving Green's tensor calculations for quantum optical effects on the nanoscale [4], multi-scale geometries [5] etc.), on optimization procedures [6] and on real-time calculations, e.g., for computer graphics and computational vision.

A well-known alternative is to adopt modal (aka spectral) methods, whereby one initially sets the source b to zero, and reformulates the model equations as an eigenvalue problem. It is required to compute the infinite set of modes (also referred to as eigenfunctions or eigenvectors) of the system which represent possible solutions of the problem supported by the structure in the absence of any external source. (a typical example from the context of electromagnetism are waveguide modes). Then, for a given source, the solution of the scattering problem (i.e., A̅x=b) can be written as a sum of the various modes, each weighted by the spatial overlap it has with the source, and the distance the actual physical frequency has from the eigen-frequency [7, 8]. In this approach, all the problems associated with the standard procedures (inversion, etc.) are avoided, thereby potentially making the calculation particularly rapid (since only a single simulation is required).

Traditionally, there have been two main challenges in using modal methods. First, there has been no fully reliable numerical scheme for the calculation of modes of arbitrary structures. Indeed, popular commercial software for solving Maxwell's equations (e.g., COMSOL Multiphysics, CST Microwave Studio etc.) implements a modal solver which is based on the state-of-the-art knowledge. However, mode calculation is usually time- and memory-consuming, and it is hard to obtain all the modes necessary for convergence. Moreover, numerical noise causes many insignificant or (localized or longitudinal) spurious modes to be obtained and therefore, requires tedious and usually non-automatic procedures to identify and remove them [9]. When high accuracy is needed, the modal approach frequently does not converge at all and fails.

Second, while a simple solution for the scattering problem as a weighted sum of the underlying modes of the structure exists for closed, conservative systems, the analogue solution for an open and/or lossy system has not been available. Over the last few years, modal methods for open/lossy systems were developed within the electromagnetism community. In those approaches, the lack of energy conservation (due to openness or loss) was accounted for via a (global) complex eigenvalue which is the frequency [8, 10, 11]. A similar approach was developed much earlier by Harrington [12], with the difference that the eigenfunction are chosen to be currents rather than fields.

However, the modal solutions based on complex eigen-frequencies are non-orthogonal (for dispersive media) and their weighted sum is an accurate solution only inside the scatterers and exponentially large errors can arise far from them (in particular, in the regimes where the field is measurable) [7, 8].

A possible way to circumvent the this problem has been proposed by Lalanne et al. [13], which involves adding a Perfectly Matched Layer (PML) to the simulation domain, to avoid the exponential growth of the modes, along with a computation of modes that primarily reside in the PML. Unfortunately, these modes have no physical meaning, and a rather large number of them is required. Therefore, these methods are applicable to a limited range of problems and have little prospect for becoming a robust numerical approach that can be used for applications.

Recently, it was shown that a slightly different modal method (in the context of electromagnetism) in fact circumvents all the difficulties described above. In this approach [14, 15, 16], one formally splits the domain of interest into scatterers and background (objects that consist of materials whose optical properties such as dielectric function, refractive index differs from that of the background (which should constitute most of the computational domain). This enables to reformulate the Maxwell's equations as eigenvalue equations for the optical properties (namely, the refractive index or permittivity) of the (localized) scatterers rather than in terms of the (global) illumination frequency. This method gives an analytic solution for the EM fields in all space. However, a robust numerical approach for calculating the modes of arbitrarily complex scatterer geometry has not been achieved. Instead, mode calculation used the numeric procedures in existing commercial software (i.e., in the differential equation form) for complex frequencies, but still, suffered from many of the problems described above.

Previous attempts to compute these modes used a continuous set of modes (e.g., a Fourier-Bessel basis) which are slow to capture the discontinuity (giving rise to Gibbs phenomena etc., see [10]). This is a well-known difficulty in the general context of series expansions in numerical analysis. As a result, the application of standard eigenvalue search algorithms to the resulting eigenvalue problem generates highly noisy eigenvalues and eigenvectors. This is especially problematic for modes with high spatial frequencies (due to their sensitivity to the numerical grid in use). Also, this noise yields spurious longitudinal modes which have non-zero permittivity. Discarding of such spurious modes requires manual handling and a lot of experience and skill. These difficulties prevented this modal approach from being adopted widely.

It is therefore an object of the present invention to provide a method for fast solution of partial differential equations using a modal approach, which effectively eliminates noise problems and the appearance of both transverse and longitudinal spurious modes.

It is another object of the present invention to provide a method for fast solution of partial differential equations using a modal approach, which requires a substantially smaller computational effort, compared to the standard commercially-available techniques, while eliminating convergence problems or noise-induced spurious modes.

It is another object of the present invention to provide a method for fast solution of partial differential equations using a modal approach, in which there are no missing modes.

Other objects and advantages of the invention will become apparent as the description proceeds.

### SUMMARY OF THE INVENTION

A method for providing fast and efficient solution of partial differential equations to calculate the permittivity modes of an arbitrarily complex scatterer geometry using a modal approach, comprising the steps of:
a) defining the background geometry and the scatterer's geometry;
b) embedding each scatterer in a simpler geometry;
c) calculating the base transverse modes for each embedding geometry;
d) for each scatterer:
   calculating the longitudinal modes;
   calculating the overlap matrix;
   solving and the resulting eigenvalue equation, using the base transverse modes that have been calculated for each embedding geometry and the longitudinal modes that have been calculated for the each scatterer;
e) if there is more than one scatterer, hybridizing the modes of each pair of scatterers, otherwise,
f) solving the resulting eigenvalue equation for the complete structure;
g) projecting the source is on target modes; and
h) substituting the result is in the final equation.

A limited set of overlap integrals between the modes of an embedding simple shape may be computed, for allowing solving a smaller eigenvalue equation for the modes.

The modes of an arbitrarily complex scatterer embedded inside a bigger scatterer of a simple shape may be expanded, using the completeness of the permittivity modes inside the scatterer.

The eigenvalues of the simpler shapes may be computed using an algebraic equation.

The entries in the eigenvalue equation may be overlap integrals of the known modes over the domain of an arbitrary scatterer.

The calculation of modes may incorporate naturally the mode discontinuity at the scatterer boundary, for minimizing the size of the eigenvalue problem that has to be solved.

The overlap integrals may be evaluated by replacing the volume integrals by surface integrals and the surface integrals by line integrals.

Modes of the target geometry may be expanded based on the modes of a simpler geometry.

A system for providing fast and efficient solution of partial differential equations to calculate the permittivity modes of an arbitrarily complex scatterer geometry using a modal approach, comprising at least one processor, adapted to:
a) define the background geometry and the scatterer's geometry;
b) embed each scatterer in a simpler geometry;
c) calculate the base transverse modes for each embedding geometry;
d) for each scatterer:
   calculate the longitudinal modes;
   calculate the overlap matrix;
   solve and the resulting eigenvalue equation, using the base transverse modes that have been calculated for each embedding geometry and the longitudinal modes that have been calculated for the each scatterer;
e) hybridize the modes of each pair of scatterers if there is more than one scatterer, otherwise,
f) solve the resulting eigenvalue equation for the complete structure; g) project the source is on target modes; and
h) substitute the result is in the final equation.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 shows a schematic illustration of the re-expansion approach—the actual scatterer, defined by θ(r), is embedded in a larger simple shape (a circle in the current case, defined by θ0(r)); and

FIG. 2 is a flowchart of the fast solution of partial differential equations using a modal approach, according to an embodiment of the invention.

### DETAILED DESCRIPTION OF THE INVENTION

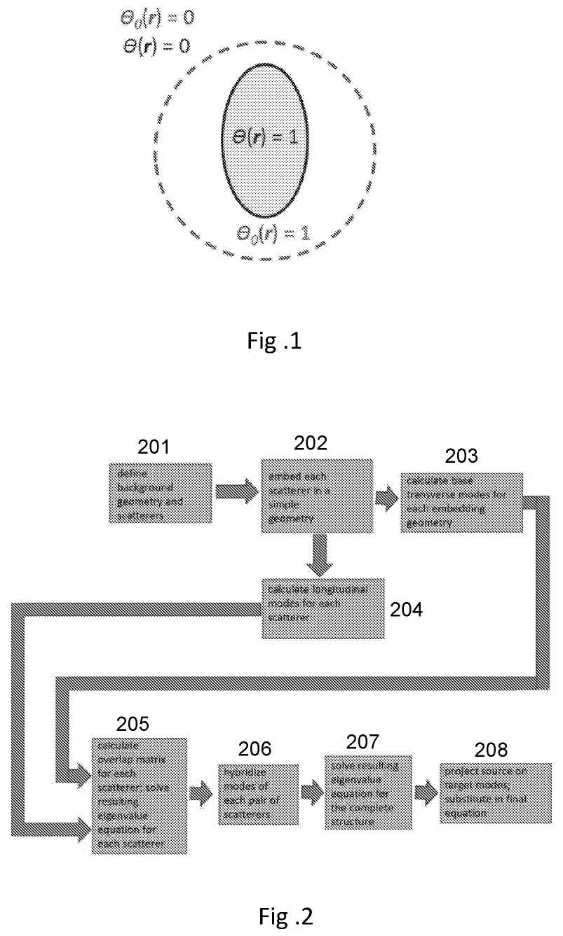

The present invention proposes a method for fast solution of partial differential equations, using a modal approach. The new proposed method provides an efficient way to calculate the permittivity modes of an arbitrarily complex scatterer geometry, which does not require solving a differential equation by discretizing all space. Instead, the proposed method requires just a computation of a limited set of overlap integrals between the modes of an embedding simple shape and a solution of a small eigenvalue problem. In particular, the completeness of the permittivity modes inside the scatterer is exploited to expand the modes (\tilde{E}) of an arbitrarily complex scatterer (defined by θ(r), shown in FIG. 1) embedded inside a bigger scatterer of a simple shape (e.g., a slab, a circle or a sphere, defined by θ₀(r)), namely,

$$\tilde{E} ( r ) = {\sum }_{n} {c}_{n} {E}_{n} ( r ) , \qquad ( 1 )$$

where Eₙ are the modes of the simple shape and cₙ is a vector of weights. As the eigenvalues of the latter simple shapes Eₙ are relatively easy to compute using just an algebraic equation (the so-called dispersion relations), the computational burden is mostly to calculate the weights cₙ. A simple substitution into the underlying equations shows that the vector cₙ is a solution of an eigenvalue equation whose size is determined by the number of known modes Eₙ that significantly contribute to the modes of the arbitrary scatterer \tilde{E}. The entries in that eigenvalue equation are just overlap integrals of the known modes over the domain of the arbitrary scatterer. Hence, discretization of all space is unnecessary. Discretization is necessary just for the matrix element calculation, the number of which is significantly smaller than what would have been the number of elements necessary to discretize all space.

FIG. 1 shows a schematic illustration of the re-expansion approach. The actual scatterer, defined by θ(r), is embedded in a larger simple shape (a circle in the current case, defined by θ₀(r)).

The modes of the simple structures have an a-priory known functional form, and the eigenvalue itself is found from the roots of the dispersion relations, which are algebraic rather than differential equations. A highly efficient way to find those (generally complex) roots is the contour methods ([29]). However, an additional set of modes is required, specifically, modes that incorporate the permittivity discontinuity, the so-called longitudinal modes, which are characterized by zero permittivity eigenvalues.

The present invention proposes an efficient way to compute the longitudinal modes, according to which, the calculation of modes incorporates naturally the mode discontinuity at the scatterer boundary. This way, a minimal set of modes is found, typically 2-3 orders of magnitude smaller compared with previous approaches [10]. This minimizes the size of the eigenvalue problem that has to be solved, and effectively eliminates noise problems and the appearance of both transverse and longitudinal spurious modes.

The proposed method uses techniques that allow evaluating the resulting overlap integrals by replacing the volume integrals by surface integrals and the surface integrals by line integrals, in order to compute the modes more rapidly. This is an improvement over previous implementations [10], which involve only simple perturbations for which the overlap integrals could be calculated analytically. As a result, this method requires a substantially smaller computational effort, compared to the standard commercially-available techniques, while eliminating convergence problems or noise-induced spurious modes. Also, there are no missing modes.

The proposed method makes modal methods a powerful computational tool, which is characterized by high speed, high accuracy and high reliability.

The following examples show a rapid calculation of the overlaps for various non-trivial shapes and overall computation times of modes and scattering problems, which is several order of magnitude faster than available commercial software.

### Generalized Normal Mode Expansion (GENOME)

One goal of the present invention is to solve Maxwell's equations with an arbitrary source J(r),

$$∇ \times ( ∇ \times E ) - {k}^{2} ϵ ( r ) E = i ω {μ}_{0} J , \qquad ( 2 )$$

where harmonic e^{-iωt} time variation and non-magnetic media are being assumed in this case. It is done by first obtaining the Lippmann-Schwinger equation and then, expanding the solution in terms of its eigenmodes. It is assumed that the structure defined by its permittivity profile ϵ(r) rests in a background of uniform permittivity ϵ_{b}. This permits the manipulation of (2) to yield

$$∇ \times ( ∇ \times E ) - {k}^{2} {ϵ}_{b} E = i ω {μ}_{0} J + {k}^{2} ( ϵ ( r ) - {ϵ}_{b} ) E . \qquad ( 3 )$$

This can be solved using the Green's function for uniform media,

$$∇ \times ( ∇ {( \times {G}^{=} )}_{0} ) - {k}^{2} {ϵ}_{b} {{G}^{=}}_{0} = {I}^{=} {δ}^{3} ( r - {r}^{′} ) , \qquad ( 4 )$$

which has a simple known analytic form G̅₀(|r−r′|) depending on the dimensionality of the problem. Applying (4) to both terms on the RHS of (3) yields its Green's function solution, the Lippmann-Schwinger equation,

$$E ( r ) = {E}_{0} ( r ) + {k}^{2} \int {{G}^{=}}_{0} ( \vert r - {r}^{′} \vert ) ( ϵ ( {r}^{′} ) - {ϵ}_{b} ) E ( {r}^{′} ) {dr}^{′} . \qquad ( 5 )$$

The term E₀(r) is the known radiation pattern of external sources in a uniform background

$${E}_{0} ( r ) = i {ωμ}_{0} \int {{G}^{=}}_{0} ( \vert r - {r}^{′} \vert ) J ( {r}^{′} ) {dr}^{′} , \qquad ( 6 )$$

To solve (5), the appropriate normal modes of the system are being defined, obtained by neglecting source terms in (3). Attention is restricted to the simpler case obtained by assuming that the permittivity of the inclusion is uniform, so that the simulation domain is defined by only two permittivities: an eigenpermittivity ϵₘ applicable to the inclusion's interior, and the fixed background ϵ_{b},

$$∇ \times ( ∇ \times {E}_{m} ) - {k}^{2} {ϵ}_{b} {E}_{m} = \frac{1}{{s}_{m}} {k}^{2} {ϵ}_{b} θ ( r ) {E}_{m} . \qquad ( 7 )$$

where sₘ is the mth eigenvalue,

$$\frac{1}{{s}_{m}} ≡ \frac{{ϵ}_{m} - {ϵ}_{b}}{{ϵ}_{b}} , \qquad ( 8 )$$

θ(r) is a step function that is unity inside the inclusion and zero elsewhere. Alternatively, the integral form of the eigenvalue equation can be obtained from (5) by neglecting E₀,

$${s}_{m} {E}_{m} ( r ) = {k}^{2} {ϵ}_{b} \int {{G}^{=}}_{0} ( \vert r - {r}^{′} \vert ) θ ( {r}^{′} ) {E}_{m} ( {r}^{′} ) {dr}^{′} . \qquad ( 9 )$$

This provides the modal expansion solution of the Lippmann-Schwinger equation (5) for the simpler case of a uniform inclusion permittivity ϵᵢ, which after some manipulation is

$$E ( r ) = {E}_{0} ( r ) + \frac{i}{{ωϵ}_{0}} {\sum }_{m} {E}_{m} ( r ) \frac{{ϵ}_{i} - {ϵ}_{b}}{( {ϵ}_{m} - {ϵ}_{i} ) ( {ϵ}_{m} - {ϵ}_{b} )} \int {E}_{m}^{†} ( {r}^{′} ) \cdot J ( {r}^{′} ) {dr}^{′} . \qquad ( 10 )$$

Thus, the solution for any source configuration can be obtained almost immediately once the modes of the structure are available.

Returning to the defining differential equation (7), there are some properties of the modes. It allows three types of modes, of which one shall use two: transverse and longitudinal electric, referred hereafter simply as longitudinal. Transverse modes have a nonzero eigenvalue ϵₘ, so the eigenvalue equation has two forms in the two piecewise uniform regions,

$$∇ \times ( ∇ \times {E}_{m} ) - {k}^{2} {ϵ}_{m} {E}_{m} = 0 r ∈ interior \qquad ( 11 )$$

$$∇ \times ( ∇ \times {E}_{m} ) - {k}^{2} {ϵ}_{b} {E}_{m} = 0 r ∈ exterior .$$

These modes are divergence-free within the two regions, which can be seen by applying the divergence operator to each of (11), obtaining ∇·Eₘ=0 in both cases. They are not divergence-free along the boundary between the interior and the exterior, but nevertheless are called transverse modes.

Typically, only transverse modes are necessary for the expansion (10), since the solution E(r) is also everywhere transverse except along the boundary and locations where the source J(r) is nonzero. These non-transverse parts of E(r) are accounted for by the transverse modes and by E₀(r), respectively. However, since the interest is in perturbing the structure θ(r) and its interfaces, the locations where the solution E(r) is non-transverse are also perturbed, requiring an additional set of longitudinal modes.

Longitudinal modes arise from the special set of eigenfunctions of (7) that exist when sₘ=−1 or ϵₘ=0. The eigenvalue equation then reduces to

$$∇ \times ( ∇ \times {E}_{m} ) = 0 , \qquad ( 12 )$$

in the interior. In contrast to the transverse modes, these modes are nonzero only inside the inclusion. The field is identically zero in the exterior since the index contrast with the background is infinite.

It will be shown that longitudinal electric modes are generated from the subset of (12) where ∇×Eₘ=0, and their non-divergence-free property is also proved.

The implementation of the proposed Generalized Normal Mode Expansion method requires the calculation of 3D integrals, for the computations of the mode overlaps, as shown in eq. ( . . . ). This can be done, for example, by any software hat is based on the Finite Element Method (such as freefem.org—FreeFEM is a partial differential equation solver for non-linear multi-physics systems in 1D, 2D, 3D and 3D border domains, getfem.org—GetFEM is an open source library based on collaborative development. It aims to offer the most flexible framework for solving potentially coupled systems of linear and nonlinear partial differential equations with the finite element method, etc.). The computation of the target modes and eigenvalues may be performed by software that performs eigenvalue search of given matrices. This can be, for example, using the standard LAPACK (a standard software library for numerical linear algebra) package (implemented, e.g., via MATLAB).

The size of the simulated domain determines the memory and processor requirements. Those are expected to be significantly smaller compared with the implementation of standard numerical methods.

### The Re-Expansion Method

The main computational effort in any modal expansion method is typically devoted to finding the modes, and there is always a need for a fast, efficient, and reliable method. It is may be achieved by expanding modes of the target geometry, defined by θ(r), using the modes of a simpler geometry θ(r) as a basis. The aim is to find the modes of an arbitrary geometry by perturbing the modes of a much simpler geometry. Because the basis is complete, the method is not merely perturbative in the traditional sense, as one can treat “perturbations” of any depth, successfully generating the modes of any target geometry to any desired accuracy.

It is required to solve the eigenvalue equation

$$∇ \times ( ∇ \times {\tilde{E}}_{μ} ) - {k}^{2} {ϵ}_{b} {\tilde{E}}_{μ} = \frac{1}{{\tilde{s}}_{μ}} {k}^{2} {ϵ}_{b} \tilde{θ} ( r ) {\tilde{E}}_{μ} , \qquad ( 13 )$$

where \tilde{E}_{μ} and \tilde{s}_{μ} are the perturbed eigenmodes and eigenvalues, and \tilde{θ}(r) differs from θ(r),

$$\tilde{θ} ( r ) = θ ( r ) + Δ θ ( r ) . \qquad ( 14 )$$

It is assumed that the modes of the geometry defined by θ(r) are known, while Δθ(r) can be arbitrary, as long as it is contained within the so-called interior of θ(r).

The solution proposed by the present invention focuses on piecewise uniform structures, so Δθ(r) has discontinuous steps. This case is perhaps the most difficult to treat, since the eigenmodes also have discontinuities. However, the formulation can be applied unmodified for Δθ(r) with smooth spatial variations, or even tensorial perturbations.

### Derivation

The derivation follows the familiar pattern of expanding the target differential equation using a complete basis, initially with unknown coefficients. Then a project is performed to evaluate the coefficients, resulting in a set of integrals over the perturbation that populate a linear system of equations, which is solved for the final solution.

The perturbed modes \tilde{E}_{μ} are expanded using the modes Eₘ as a basis, since they are completely inside the inclusion (as illustrated in Eq. (1) above),

temporarily suppressing the index μ for brevity. Then (13) becomes

$$∇ \times ( ∇ \times \tilde{E} ) - {k}^{2} {ϵ}_{b} \tilde{E} - {k}^{2} ( \tilde{ϵ} - {ϵ}_{b} ) \tilde{θ} ( r ) \tilde{E} = 0 \qquad ( 16 )$$

$${\sum }_{n} {c}_{n} [ ∇ \times ( ∇ \times {E}_{n} ) - {k}^{2} {ϵ}_{b} {E}_{n} - {k}^{2} ( \tilde{ϵ} - {ϵ}_{b} ) [ θ ( r ) + Δ θ ( r ) ] {E}_{n} ] = 0 .$$

The first two terms satisfy the eigenvalue equation of the basis modes (7),

$${\sum }_{n} {c}_{n} [ {k}^{2} ( {ϵ}_{n} - {ϵ}_{b} ) θ ( r ) {E}_{n} - {k}^{2} ( \tilde{ϵ} - {ϵ}_{b} ) [ θ ( r ) + Δ θ ( r ) ] {E}_{n} ] = 0. \qquad ( 17 )$$

The unknown coefficients are found by projecting onto the basis modes via multiplication by adjoint modes Eₘ^{†} and integrating over all space,

$${\sum }_{n} {c}_{n} \int [ ( {ϵ}_{n} - {ϵ}_{b} ) {E}_{m}^{†} \cdot θ ( r ) {E}_{n} - ( \tilde{ϵ} - {ϵ}_{b} ) {E}_{m}^{†} \cdot [ θ ( r ) + Δ θ ( r ) ] {E}_{n} ] dr = 0. \qquad ( 18 )$$

This may be simplified using the orthogonality of the basis modes,

$$\int {E}_{m}^{†} \cdot θ ( r ) {E}_{n} dr = {δ}_{mn} , \qquad ( 19 )$$

which is described later. This yields

$$( {ϵ}_{m} - {ϵ}_{b} ) {c}_{m} = ( \tilde{ϵ} - {ϵ}_{b} ) {\sum }_{n} [ {δ}_{mn} + \int {E}_{m}^{†} Δ θ ( i ) \cdot {E}_{n} dr ] {c}_{n} \qquad ( 20 )$$

$$\tilde{s} {c}_{m} = {s}_{m} {\sum }_{n} [ {δ}_{mn} + {V}_{mn} ] {c}_{n} ,$$

where V has been defined with matrix elements

$${V}_{mn} = \int {E}_{m}^{†} ( r ) \cdot Δθ ( r ) {E}_{n} ( r ) dr . \qquad ( 21 )$$

This yields a system of linear equations to be solved for the perturbed modes

$$diag ( {s}_{m} ) ( V + I ) c = \tilde{s} c , \qquad ( 22 )$$

where I is the identity matrix and

$$diag ( {s}_{m} ) = [ \begin{matrix}{s}_{1} & & & \\ & {s}_{2} & & \\ & & ⋱ & \\ & & & {s}_{m}\end{matrix} ] , V = [ \begin{matrix}{V}_{11} & {V}_{12} & & \\ {V}_{21} & {V}_{22} & & \\ & & ⋱ & \\ & & & {V}_{mn}\end{matrix} ] , c = [ \begin{matrix}{c}_{1} \\ {c}_{2} \\ ⋮ \\ {c}_{m}\end{matrix} ] . \qquad ( 23 )$$

Solution of (22) yields the perturbed modes \tilde{E}_{μ} and their eigenvalues \tilde{s}_{μ} for the geometry defined by \tilde{θ}(r), expanded in terms of the basis modes Eₘ. The numerical implementation of (22) first requires preparation of all the basis modes, both transverse and longitudinal, considered further in the description. Next, the matrix elements of (21) must be computed via integrals considered later. Finally, (22) is ready to be solved, using any numerical linear algebra package for small dense systems. For numerical convenience, the system of equations (22) should be symmeterized, a process that is specified later on. After solving (22), a few minor steps complete the process, while enabling the solution of the modal expansion solution (10). The perturbed adjoint modes adjoint modes are necessary, \tilde{E}ₘ^{†} which are considered further in the description. The modes \tilde{E}_{μ} also require normalization, which is performed later.

### Adjoint Form

The modal expansion solution (10) requires not only the direct modes Eₘ, but also requires the adjoint modes Eₘ^{†} for the purposes of projection. All adjoint modes satisfy the same governing eigenvalue equation and have the same eigenvalues as the direct modes. This is a consequence of the symmetry of the free space Green's function (9). Furthermore, the modes are self-adjoint, that is, the adjoint modes Eₘ^{†} are identical to Eₘ and the orthogonality relation is

$$\int {E}_{m}^{†} \cdot θ ( r ) {E}_{n} d r = {δ}_{m n} . \qquad ( 36 )$$

This is true unless the structure exhibits a form of symmetry that permits degeneracy. In this case, the set of degenerate modes are sometimes related by a non-standard orthogonality relation. Typically though, the adjoint mode is obtained by reversing the functional dependence along the direction of symmetry, for example e^{imθ}→e^{-imθ}, so the basis is no longer self-adjoint. However, even in this case, a self-adjoint basis can be obtained by using the set {sin(mθ), cos(mθ)} for the angular variation.

According to one embodiment, the analytical modes of the cylinder are employed as a basis, incorporating the complex cylindrical harmonics, {e^{imθ}}. Despite the non-self-adjoint nature of this basis, it is preferred due to convenience when evaluating the matrix elements of V, (21). Use of this non-self-adjoint basis means that the expansion of the perturbed adjoint modes may differ from the direct modes,

$${\tilde{E}}^{†} ( r ) = {\sum }_{m} {c}_{m}^{†} {E}_{m}^{†} ( r ) , \qquad ( 37 )$$

where cₘ^{†} labels the coefficients. Explicit computation is used to prove this fact. The derivation for these coefficients is almost identical as before, beginning instead with the adjoint form

$$∇ \times ( ∇ \times {\tilde{E}}^{†} ) - {k}^{2} {ϵ}_{b} {\tilde{E}}^{†} - {k}^{2} ( \tilde{ϵ} - {ϵ}_{b} ) \tilde{θ} ( r ) {\tilde{E}}^{†} = 0. \qquad ( 38 )$$

Inserting the expansion (37) and eventually projecting onto the direct mode Eₙ gives

$${\sum }_{m} {c}_{m}^{†} \int [ ( {ϵ}_{m} - {ϵ}_{b} ) {E}_{m}^{†} \cdot θ ( r ) {E}_{n} - ( \tilde{ϵ} - {ϵ}_{b} ) {E}_{m}^{†} \cdot [ θ ( r ) + Δ θ ( r ) ] {E}_{n} ] d r = 0. \qquad ( 39 )$$

Due to slight differences in the subscripts, a system of linear equations featuring the transpose of matrix elements V is obtained, defined in (21),

$$diag ( {s}_{m} ) ( {V}^{⊤} + I ) {c}^{†} = \tilde{s} {c}^{†} . \qquad ( 40 )$$

It should be noted that in the notation c^{†} is a column vector. Thus, the coefficients of expansion for the adjoint fields, cₙ^{†}, are identical to cₙ if V is symmetric or complex symmetric. The familiar case of complex conjugate adjoints are obtained if V is Hermitean.

The symmetry of V does not depend on the perturbation geometry Δθ(r), since this is simply a scalar function. Instead, it only depends the relationship between the basis modes Eₘ and their adjoints Eₘ^{†}, which in turn stems from the symmetry properties of the operator G̅₀(|r−r′|) of the governing eigenvalue problem (9). It can be seen that because G̅₀(|r−r′|) is symmetric, V can also be put into symmetric form, thus providing a simple relationship between cₙ and cₙ^{†}.

### Symmetry

For numerical convenience, the eigenvalue equation (22) may be cast in a more symmetric form by dividing and multiplying by diag(\sqrt{sₘ}),

$$diag ( \sqrt{{s}_{m}} ) ( V + I ) diag ( \sqrt{{s}_{m}} ) [ diag ( \frac{1}{\sqrt{{s}_{m}}} ) c ] = \tilde{s} [ diag ( \frac{1}{\sqrt{{s}_{m}}} ) c ] . \qquad ( 41 )$$

However, an impediment to full symmeterization remains since the matrix V may itself not possess any symmetry properties, such as being equal to its transpose V^{τ} or its conjugate transpose V*. In this case, the lack of symmetry in V is due to the unusual orthogonality relationship obeyed by the cylindrical harmonics {exp(imθ)}, which can be remedied by switching to the trigonometric basis {cos(mθ),sin(mθ)}. Thus, full symmeterization can be attained since Vₘₙ bears sufficient similarity to Vₙₘ that they can be symmeterized using a similarity transform S,

$$S V {S}^{- 1} = W = {S}^{- 1} {V}^{⊤} S , \qquad ( 42 )$$

where W^{τ}=W. The second equality of (42) is a consequence of the first equality and the definitions of S and W. In more concrete terms, a unitary basis transformations of the type

$$\sqrt{2} [ \begin{matrix}cos ( m θ ) \\ sin ( m θ )\end{matrix} ] = \frac{\sqrt{2}}{2} [ \begin{matrix}1 & 1 \\ - i & i\end{matrix} ] [ \begin{matrix}{e}^{- i m θ} \\ {e}^{i m θ}\end{matrix} ] \qquad ( 43 )$$

is required, to be applied to the appropriate pairs of V. The identity J₋ₘ(r)=(−1)^{m}Jₘ(r) can be employed if Bessel functions of negative order require conversion. In this way, the desired similarity transform S can be constructed.

The eigenvalue equation is now obtained

$$diag ( \sqrt{{s}_{m}} ) ( S V {S}^{- 1} + I ) diag ( \sqrt{{s}_{m}} ) [ diag ( \frac{1}{\sqrt{{s}_{m}}} ) Sc ] = \tilde{s} [ diag ( \frac{1}{\sqrt{{s}_{m}}} ) Sc ] , \qquad ( 44 )$$

which after simplification yields the desired symmeterized form

$$diag ( \sqrt{{s}_{m}} ) ( W + I ) diag ( \sqrt{{s}_{m}} ) b = \tilde{s} b , \qquad ( 45 )$$

featuring the rescaled eigenvectors

$$b = diag ( \frac{1}{\sqrt{{s}_{m}}} ) Sc . \qquad ( 46 )$$

Equivalently, the adjoint eigenvalue equation (40) may be symmeterized, using the rescaled eigenvector

$$b = diag ( \frac{1}{\sqrt{{s}_{m}}} ) {S}^{- 1} {c}^{†} , \qquad ( 47 )$$

again yielding (45). The coefficients {cₘ} and adjoint coefficients {cₘ^{†}} are now obtained from the same eigenvalue equation.

This has several advantages: it eliminates any numerical noise arising from independently solving two similar eigensystems, it eases the numerical burden, and enables a more streamlined numerical implementation.

### Normalization and Orthogonality

All modal expansion methods require that the modes be normalized, as this enables projection. Thus, the following condition should be evaluated

$${N}_{μ}^{2} \int {\tilde{E}}_{μ}^{†} ( r ) \cdot \tilde{θ} ( r ) {\tilde{E}}_{μ} ( r ) d r = 1 , \qquad ( 48 )$$

where N_{μ} is the normalization factor. Thus, the modes produced by numeric solution of the linear system of equations (22) are not necessarily correctly normalized, since most linear algebra packages typically normalize according to linear algebra definitions. However, it was shown that a convenient evaluation of (48) is possible if the basis modes are already normalized, by expanding

$$\begin{matrix}\int {\tilde{E}}_{μ}^{†} ( r ) \tilde{θ} ( r ) {\tilde{E}}_{μ} ( r ) d r = {\sum }_{m} {\sum }_{n} {c}_{m}^{†} {c}_{n} \int {E}_{m}^{†} ( r ) \cdot [ θ ( r ) + Δ θ ( r ) ] {E}_{n} ( r ) d r \\ = {\sum }_{m} {\sum }_{n} {c}_{m}^{†} {δ}_{m n} {c}_{n} + {\sum }_{m} {\sum }_{n} {c}_{m}^{†} {V}_{m n} {c}_{n} \\ = {( {c}^{†} )}^{⊤} ( V + I ) c \\ = {{\tilde{s}}_{μ} ( {c}^{†} )}^{⊤} diag ( {s}_{m}^{- 1} ) c .\end{matrix} \qquad ( 49 )$$

To obtain the result, the orthonormality of the basis modes (19) in the second equality of (49) has been exploited, and the eigenvalue equation (22) in the fourth equality.

The normalization integral is thus reduced to a sum,

$$\frac{1}{{N}_{μ}^{2}} = {\tilde{s}}_{μ} {\sum }_{m} \frac{{c}_{m}^{†} {c}_{m}}{{s}_{m}} . \qquad ( 50 )$$

The evaluation is even simpler in terms of the symmeterized coefficients bₘ defined in (46) and (47),

$$\frac{1}{{N}_{μ}^{2}} = {\tilde{s}}_{μ} {\sum }_{m} {b}_{m}^{2} . \qquad ( 51 )$$

This is because Σₘ bₘ²=1 is precisely the dot product between the normalized left and right eigenvectors of the symmeterized matrix operator in (45), which is naturally enforced by some linear algebra packages.

An extension of (49) can be used to test the orthonomality of modes, by numerically confirming the equality

$${( {D}^{†} )}^{⊤} diag ( {s}_{m}^{- 1} ) Ddiag ( {\tilde{s}}_{μ} ) = I , \qquad ( 52 )$$

where D is a matrix of normalized coefficients composed of columns N_{μ}c_{μ}, D^{†} is composed of columns of N_{μ}c_{μ}^{†}, and diag(\tilde{s}_{μ}) is a diagonal matrix of all eigenvalues {\tilde{s}_{μ}}. The identity (52) is numerically satisfied to machine precision regardless of truncation, since the eigenvectors of a complex symmetric matrix (45) obey a complex orthogonality condition from which (52) can be deduced. One interesting consequence is that the set of generated modes {\tilde{E}_{μ}} is automatically orthogonal. The exception is modes belonging to the same eigenvalue, such as symmetry degenerate modes, which need to be orthogonalized manually.

### Transverse Basis Modes

Perturbation methods uses a basis of known modes of a simple geometry to expand the modes of a complex target geometry. In broad terms, the transverse basis modes reproduce the smooth near-field features and all of the far-field features of the target modes. Typically, modes of circles and spheres are employed, as these modes can be obtained analytically by separation of variables, ultimately reducing to a transcendental equation which can be solved for the eigenvalues. A brief overview of these well known results is provided, pertaining primarily to 2D modes of a circle. Very similar procedures apply in 1D and 3D, and only the form of the mathematical functions differ.

Applying separation of variables to the Lippmann-Schwinger equation (7) yields the function form of the eigenmodes. For structures that are invariant in the third dimension, two distinct polarizations exist: transverse electric and transverse magnetic. The field profiles for the two cases differ. For the TM modes, it is

$${E}_{z} = {H}_{m} ( {α}_{b} r ) {e}^{im θ} , r ∈ exterior \qquad ( 53 )$$

$${E}_{z} = {J}_{m} ( {α}_{m} r ) {e}^{im θ} , r ∈ interior .$$

For the TE modes, it is simpler to specify the magnetic fields

$${H}_{z} = {H}_{m} ( {α}_{b} r ) {e}^{im θ} , r ∈ exterior \qquad ( 54 )$$

$${H}_{z} = {J}_{m} ( {α}_{m} r ) {e}^{im θ} , r ∈ interior ,$$

and use the Maxwell curl equation

$$E = \frac{i}{k ϵ} ∇ \times H \qquad ( 55 )$$

to obtain the electric fields. The magnetic field representation is preferred when for example, performing integrals over the perturbation, which is described later in the description.

The propagation constants in (53) and (54) are related to the background permittivity and the as yet unknown eigenpermittivity,

$${α}_{m}^{2} = {k}^{2} {ϵ}_{m} , {α}_{b}^{2} = {k}^{2} {ε}_{b} , \qquad ( 56 )$$

The eigenpermittivity is found via a field stitching exercise at the boundary between the interior and exterior, defined at radius B. This leads to a form of the well-known dispersion relation of a step-index fiber,

$$( \frac{1}{{α}_{m} B} \frac{{J}_{m}^{′} ( {α}_{m} B )}{{J}_{m} ( {α}_{m} B )} - \frac{1}{{α}_{b} B} \frac{{H}_{m}^{′} ( {α}_{b} B )}{{H}_{m} ( {α}_{b} B )} ) ( \frac{{ϵ}_{m}}{{α}_{m} B} \frac{{J}_{m}^{′} ( {α}_{m} B )}{{J}_{m} ( {α}_{m} B )} - \frac{{ϵ}_{b}}{{α}_{b} B} \frac{{H}_{m}^{′} ( {α}_{b} B )}{{H}_{m} ( {α}_{b} B )} ) = 0. \qquad ( 57 )$$

### Orthogonality

Orthogonality is an important property that permits projection. The transverse modes satisfy the orthogonality relation (19), revealing the simple form of the adjoint modes Eₘ^{†} in the process. However, there are two subtleties associated with symmetry and longitudinal modes that shall be also discussed.

The proof of orthogonality is similar to other such proofs, proceeding from a construction that involves the operator which generates the eigenmodes,

$$\int \int {E}_{n}^{†} ( r ) \cdot θ ( r ) {{G}^{=}}_{0} ( \vert r - {r}^{′} \vert ) θ ( {r}^{′} ) {E}_{m} ( {r}^{′} ) {drdr}^{′} = \int {E}_{n}^{†} ( r ) \cdot θ ( r ) \int {{G}^{=}}_{0} ( \vert r - {r}^{′} \vert ) θ ( {r}^{′} ) {E}_{m} ( {r}^{′} ) {dr}^{′} dr = {s}_{m} \int {E}_{n}^{†} ( r ) \cdot θ ( r ) {E}_{m} ( r ) dr . \qquad ( 58 )$$

Eₙ^{†}(r) is a column vector. Considering the alternative way of evaluating the construction,

$$\int \int {E}_{n}^{†} ( r ) \cdot θ ( r ) {{G}^{=}}_{0} ( \vert r - {r}^{′} \vert ) θ ( {r}^{′} ) {E}_{m} ( {r}^{′} ) {drdr}^{′} = \int [ \int {{G}^{=}}_{0}^{⊤} ( \vert r - {r}^{′} \vert ) θ ( r ) {E}_{n}^{†} ( r ) dr ] \cdot {E}_{m} ( {r}^{′} ) θ ( {r}^{′} ) {dr}^{′} = {s}_{n} \int {E}_{n}^{†} ( {r}^{′} ) \cdot θ ( {r}^{′} ) {E}_{m} ( {r}^{′} ) {dr}^{′} , \qquad ( 59 )$$

which follows because the dot product implies transposition, a·b≡a^{τ}b. [∫G̅₀^{τ}(|r−r′|)θ(r)Eₙ†(r)dr] may be simplified with one assumption,

$${E}_{m}^{†} = {E}_{m} ( r ) , \qquad ( 60 )$$

that adjoint is simply the original field. Then, [∫G̅₀^{τ}(|r−r′|)θ(r)Eₙ†(r)dr] satisfies the defining eigenvalue equation due to the symmetry of the Green's tensor both under transposition and the interchange of r and r′,

$${{G}^{=}}_{0}^{⊤} ( \vert r - {r}^{′} \vert ) = {{G}^{=}}_{0} ( \vert r - {r}^{′} \vert ) . \qquad ( 61 )$$

Combining these results, the following is obtained

$$( {s}_{n} - {s}_{m} ) \int {E}_{n}^{†} ( r ) \cdot θ ( r ) {E}_{m} ( r ) dr = 0 , \qquad ( 62 )$$

so eigenvectors belonging to different eigenvalues are orthogonal. The form of the adjoint necessary to yield orthogonality has been also identified. These properties are guaranteed by the complex symmetric nature of the Green's tensor. However, (62) is silent on the orthogonality of degenerate modes that have the same eigenvalue. Indeed, such modes will not automatically be orthogonal, and it often needs to be enforced by some other means.

Two cases are relevant to this issue: degeneracy due to symmetry, and the set of longitudinal modes.

For modes that are degenerate due to symmetry, one way to obtain an orthogonal set is by blind application of say the Gram-Schmidt algorithm, using the integral in (62) as the metric. The resulting eigenmodes will be orthogonal, but typically will not have any recognisable symmetry properties upon visual inspection. This is not problematic for numerical purposes, but can hinder physical interpretation. Alternatively, one can consider the set of symmetry operations that leave the structure invariant. The eigenmodes Eₘ of Green's tensor in (10) will simultaneously be eigenmodes of these symmetry operations. Just as the properties of the operator (10) impose an orthogonality relation on its eigenmodes, the symmetry operations impose an orthogonality relation on its eigenmodes. While the operator (10) is unable to establish orthogonality among a symmetry degenerate set, the symmetry operations can. In practice, the formal properties of the symmetry operations do not need to be analyzed.

Instead, orthogonality can be established, after a degenerate set of eigenmodes has been found, by choosing the appropriate linear combination, such that they are also eigenmodes of the symmetry operations. For more complex symmetries, the tools of group theory can be used.

Several types of symmetry such as continuous rotational symmetry, continuous translational symmetry, and discrete translational symmetry (also known as periodicity) may be considered. The eigenmodes of these symmetry operations are known to have the spatial variation e^{imθ}, e^{ikz}, and e^{ik}^{_{B}}^{R}, with the latter applicable to any lattice point R. However, a problem arises when these spatial variations are inserted into the integral of (62), and integration is performed along the direction of symmetry. The result is zero, for example, ∫e^{imθ} e^{imθ} dθ=0, arriving at the paradoxical conclusion that each mode is orthogonal to itself. This can be remedied by using the {cos mθ, sin mθ} basis, instead. Since one wish to use the e^{imθ} eigenmodes, their properties will be described.

All symmetry operators are orthogonal operators, satisfying the property [symbol] Ŝ_{ψ}|Ŝ_{ϕ} [symbol] = [symbol] ψ|ϕ [symbol] . This leads to the more familiar case of the adjoint mode being the complex conjugate, ψ^{†}=ψ*, or alternatively ψ^{†}(r)=ψ(−r). This conflicts with the definition (60), so a hybrid definition of the adjoint becomes necessary for these three symmetries. For example, if the geometry possesses both continuous rotational symmetry in θ and continuous translational symmetry in z, the adjoint may be defined as

$${E}_{m}^{†} ( r , θ , z ) = {E}_{m} ( r , - θ , - z ) . \qquad ( 63 )$$

### Longitudinal Basis Modes

Longitudinal basis modes are responsible for reproducing the near-field variations of the target modes at locations where the permittivity profile is changing. In particular, they reconstruct any field discontinuities due to step-index changes. Longitudinal basis modes are necessary because transverse basis modes satisfy Gauss' law, ∇·E=0, in regions of uniform permittivity. However, by definition, perturbations cause non-uniformities in the permittivity profile. Only the displacement field remains everywhere transverse, ∇·D=0, and E acquires a longitudinal component, ∇·≠0, wherever e varies. Thus, it is insufficient to rely solely on transverse basis modes Eₘ in constructing the perturbed modes \tilde{E}_{μ}. Since longitudinal modes are seldom used, their properties are discussed, along with a way for obtaining an appropriate minimal set of longitudinal modes.

### Definitions and Properties

The focus is on the first set of modes that arises from (12), whereby ∇×Eₘ=0, producing the longitudinal electric modes. Some of their properties are discussed, with the goal of demonstrating that they are non-divergence-free for at least one point in the inclusion interior. Firstly, rotationless vector fields can be expressed as a potential

$${E}_{m} = ∇ {ϕ}_{m} . \qquad ( 64 )$$

Since ϵₘ=0, there is infinite index contrast between the interior and exterior, and the field is identically zero outside. In order to satisfy the boundary conditions at the interface, the parallel component of the interior electric field must be zero, but the perpendicular component can be arbitrary. The first condition implies that

$${∇}_{‖} ϕ = {E}_{‖} = 0 , \qquad ( 65 )$$

along the boundary, so ϕₘ is constant here. This is directly analogous to the external surface of a perfect conductor being an equipotential surface. Due to the freedom associated with the definition (64), any constant may be added to ϕₘ without affecting Eₘ. Thus, is eas shown that the modes satisfy Dirichlet boundary conditions

$${ϕ}_{m} {\vert}_{\partial B} = 0 \qquad ( 66 )$$

where ∂B defines the interface between the interior and exterior.

The boundary conditions (66) are sufficient to demonstrate that these modes are longitudinal. Note that ∇²ϕₘ cannot be everywhere zero, otherwise Eₘ would be a constant. Since ∇² ϕₘ=∇·Eₘ cannot be everywhere zero, it may be concluded that Eₘ must have a longitudinal component. Unlike the transverse modes, great freedom exists in the construction of longitudinal modes. Indeed their functional forms can be almost arbitrary, subject only to the two restrictions (64) and (66). Since the longitudinal modes all share the same zero eigenvalue, the modes Eₘ are not in general orthogonal, as they are not subject to (62). There is also no defined differential operator for ϕₘ which would furnish an orthogonality relation. This is a minor inconvenience, as an orthogonalization procedure such as Gram-Schmidt can be applied if necessary, using (19) as the metric.

An appropriate useful basis of longitudinal modes must be constructed for use in the expansion (15). Firstly, a general orthonormal basis can be constructed via a simple prescription for separable geometries, by demanding that ϕₘ be orthogonal along each separable coordinate. This is considered later in the description, and leads to a basis based on generalized Fourier series. However, many basis modes may be required.

In particular, if sharp interfaces are present, the Fourier-Bessel basis is susceptible to Gibbs phenomenon (the peculiar manner in which the Fourier series of a piecewise continuously differentiable periodic function behaves at a jump discontinuity), resulting in numerical noise in the context of the numerical eigenvalue solution of (22). A more numerically robust minimal set can be obtained by considering the particular perturbation geometry, detailed further in the description. This results in an efficient and reliable basis, exhibiting exponential convergence.

### Fourier-Bessel Basis

For circular and spherical geometries, an orthonormal basis of longitudinal modes can be constructed using the Fourier-Bessel basis, which is capable of representing any longitudinal field. As an example, a recipe for a 2D circular domain of radius B is provided, deriving the basis from first principles by demanding orthogonality. Polar coordinates, (r, θ) are employed. In the angular direction, the continuous rotational symmetry furnishes the well known orthogonal set of cylindrical harmonics, e^{imθ}. In the radial direction, orthogonality is expressed as

$${\int }_{0}^{B} {ϕ}_{m} {ϕ}_{n} r d r = {δ}_{m n} \qquad ( 67 )$$

subject to the known boundary conditions that {ϕₘ} all be zero at r=B and be bounded at r=0. This defines a set of orthogonal functions or a generalized Fourier series, where r is the weight function. The Sturm-Liouville eigenvalue problem associated with (67) is the Bessel differential equation. The overall solution may now be constructed,

$${ϕ}_{m n} = {L}_{m n} {J}_{m} ( \frac{{u}_{m , n}}{B} r ) {e}^{im θ} , \qquad ( 68 )$$

where two indexes n, m are now employed, the normalization constant is Lₘₙ, and u_{m,n} is the n-th root of Bessel function Jₘ(z). In the simple case of a circular geometry, the adjoint modes are given by the complex conjugate,

$${ϕ}_{m n}^{†} = {ϕ}_{mn}^{*} , \qquad ( 69 )$$

since only the angular part of (68) is complex. After normalization, the desired orthonormal set is obtained.

It was observed that the construction (68) obeys the Helmholtz equation with Dirichlet boundary conditions,

$${∇}^{2} {ϕ}_{m n} + {α}_{m n}^{2} {ϕ}_{m n} = 0 , \qquad ( 70 )$$

where αₘₙ=u_{m,n}/B. Furthermore, the modes defined by (68) can now be shown to be everywhere non-transverse by explicit computation,

$$∇ \cdot {E}_{m n} = {∇}^{2} {ϕ}_{m n} = - {α}_{m n}^{2} {ϕ}_{m n} \neq 0 . \qquad ( 71 )$$

Finally, one may normalize the modes according to (19), which can be simplified to a scalar expression via

$$\begin{matrix}\int {E}_{m n}^{†} \cdot {E}_{m n} d r = \int ∇ {ϕ}_{m n}^{†} \cdot ∇ {ϕ}_{m n} d r \\ = \int ∇ \cdot ( {ϕ}_{m n}^{†} ∇ {ϕ}_{m n} ) d r - \int {ϕ}_{m n}^{†} {∇}^{2} {ϕ}_{m n} d r \\ = ∮ {ϕ}_{m n}^{†} ∇ {ϕ}_{m n} \cdot dS + {α}_{m n}^{2} \int {ϕ}_{m n}^{†} {ϕ}_{m n} d r \\ = {α}_{m n}^{2} \int {ϕ}_{m n}^{†} {ϕ}_{m n} dr .\end{matrix} \qquad ( 72 )$$

The surface integral vanishes due to the boundary condition. The radial part of the final expression can be evaluated analytically using the defining orthogonality relation,

$${\int }_{0}^{1} {J}_{l} ( {u}_{l , m} r ) {J}_{l} ( {u}_{l , n} r ) r d r = \frac{{δ}_{m n}}{2} {J}_{l + 1}^{2} ( {u}_{l , m} ) , \qquad ( 73 )$$

to yield

$${L}_{m n} = {[ \sqrt{π} {α}_{m n} {BJ}_{m + 1} ( {α}_{m n} B ) ]}^{- 1} . \qquad ( 74 )$$

Unfortunately, a large number of Fourier-Bessel modes (68) is necessary for piecewise uniform structures, an unavoidable fact when a set of smooth functions is used to expand discontinuities. This causes two problems for numerical eigenvalue routines during the solution of (22). Firstly, many spurious modes \tilde{E}_{μ} are liable to be produced, with eigenvalue \tilde{ϵ}_{μ}=0. These are longitudinal modes of the perturbed structure, so as discussed their modal fields are arbitrary and have little physical relevance for the modal expansion of (10). These can be easily identified and discarded. Unfortunately, the numerical solution of (22) often also results in some spurious modes that do not have \tilde{ϵ}_{μ}=0, probably due to numerical noise. Though perhaps easy to identify by eye via visual inspection of the modal fields, distinguishing such modes through automated methods can be difficult. Inclusion of such modes in the expansion of (10) can have disastrous consequences. Thus, using the Fourier-Bessel longitudinal modes is limited.

Secondly, even the useful modes \tilde{E}_{μ} are negatively impacted by numerical noise and sensitivity during the solution of the eigensystem (22). This manifests as highly speckled modal fields \tilde{E}_{μ}, which again is detrimental to the expansion (10). The numerical issues stem from any inaccuracy in evaluating matrix elements (21), but even if these elements have been evaluated analytically, there is also noise due to the numerical evaluation of the eigenvectors of (22). Particularly troublesome is any inaccuracy when calculating the coefficients of Fourier-Bessel modes with high spatial frequencies, as these introduce considerable numerical noise into modal fields \tilde{E}_{μ}. For these reasons, a more appropriate basis of longitudinal modes is essential for piecewise uniform structures.

### Boundary Adapted Longitudinal Mode Basis

An efficient and reliable basis of longitudinal modes can be derived for piecewise uniform scatterers. As discussed in the introduction, modes are longitudinal only in regions where the permittivity profile is changing, which is restricted to a step change at the boundary of piecewise uniform scatterers. To demonstrate, an explicit expression for the divergence of a mode \tilde{E}_{μ} was obtained, via

$$∇ \cdot {\tilde{D}}_{μ} = ∇ \cdot ( ϵ ( r ) {\tilde{E}}_{μ} ) = ϵ ( r ) ∇ \cdot {\tilde{E}}_{μ} + {\tilde{E}}_{μ} \cdot ∇ ϵ ( r ) = 0. \qquad ( 75 )$$

Now, assuming ∇ϵ(r) is nonzero only where the permittivity profile is discontinuous by Δϵ, it was found that ∇·\tilde{E}_{μ} is proportional to the field \tilde{E}_{μ} and Δϵ,

$$∇ \cdot {\tilde{E}}_{μ} = - \frac{1}{ϵ ( γ )} {\tilde{E}}_{μ} \cdot ∇ ϵ ( r ) = - \frac{Δϵ}{ϵ ( γ )} {\tilde{E}}_{μ} \cdot {n}_{p} δ ( r - {r}_{p} ) , \qquad ( 76 )$$

where rₚ defines the perturbation boundary and nₚ is the normal vector.

(76) was introduced for computational purposes, but it is opaque to interpret. Its meaning becomes clear if instead the integral form, [symbol] \tilde{D}_{μ}·dS=0 is considered. This naturally leads to the condition that \tilde{E}_{μ} is discontinuous by the ratio of permittivities across a step interface,

$${n}_{p} \cdot ( {ϵ}_{b} {\tilde{E}}_{μ}^{+} - {ϵ}_{μ} {\tilde{E}}_{\overline{μ}} ) = 0 , \qquad ( 77 )$$

where \tilde{E}_{μ}⁻ and \tilde{E}_{μ}⁺ are the fields on the interior and background side of the boundary, respectively. Thus, a localized divergence (76) merely corresponds to a discontinuity in \tilde{E}_{μ} across the boundary. Furthermore, it is also apparent that the very purpose of longitudinal modes is to reproduce this discontinuity, since the transverse modes are incapable of doing so. Thus, the aim is to introduce a set of intrinsincally discontinuous modes for this purpose. These all necessarily have a longitudinal component similar to (76).

In principle, only a single longitudinal mode defined by (76) subject to the Dirichlet boundary condition (66) is sufficient. But, neither \tilde{E}_{μ} nor AE are known prior to the solution of the eigensystem (22). Thus, instead is defined a suitably complete basis of longitudinal modes {Eₗ} for expanding \tilde{E}_{μ} so that the appropriate linear combination satisfies (76). Indeed, {Eₗ} should be capable of expanding any member of the set {\tilde{E}_{μ}}. Since (76) is only non-zero along the boundary, {Eₗ} only needs to capture the field variation along the boundary, corresponding to an expansion of the factor multiplying δ(r−r′).

As a simple example, for a 2D inclusion with an interface given by (aₚ(θ),θ) in polar coordinates, one may use the 1D set

$$∇ \cdot {E}_{l} = {∇}^{2} {ψ}_{l} = \frac{1}{2 π r} δ ( r - {a}_{p} ( θ ) ) {e}^{il θ} , \qquad ( 78 )$$

where l is some integer angular order. This corresponds to Dirac delta function in the radial direction, with a factor related to the Jacobian, while the field variation along the boundary is expanded via a Fourier series in the angular direction. This simple definition is often more than adequate for simple convex structures where aₚ(θ) is differentiable to all orders. Rapid, possibly exponential, convergence in l is possible, since Fourier series are known to converge exponentially for smooth functions on periodic domains.

For more complex structures, a simpler definition for the set {ψₗ} may be used,

$$∇ \cdot {E}_{l} = {∇}^{2} {ψ}_{l} = {w}_{l} ( r ) {δ}_{𝒞} ( r ) , \qquad ( 79 )$$

where [symbol] is defined to be the perturbation boundary, which is a closed surface in 3D and a closed contour in 2D. The special Dirac-delta function δ [symbol] (r) was employed, which has the property of having uniform weight over all of [symbol] . The advantage of uniform weight, and thus (79) over (78), becomes apparent for contours with segments parallel to the θ direction. The δ [symbol] (r) converts integrals over all space to an integral over [symbol] ,

$$\int f ( r ) {δ}_{𝒞} ( r ) dr = {∮}_{𝒞} f ( r ) dS , \qquad ( 80 )$$

reducing the integration order by one.

This is the most useful property of δ [symbol] (r) for the present invention's purposes, and in practice makes δ [symbol] (r) quite convenient to handle, as will be showed. Finally, the set {wₗ(r)} should be chosen to obtain a complete and rapidly converging basis along [symbol] , and indeed only needs to defined along [symbol] . As an example, a contour [symbol] with discontinuities can be partitioned into piecewise segments, expanding each segment using Chebyshev polynomials, which are known for their convergence properties.

For illustration purposes, a concrete evaluation of the somewhat abstract definition (79) is given, exploiting (80) to simplify (79). For example, the fundamental solution of the Laplace operator is defined as the Green's function

$${∇}^{2} {G}_{0} ( r , {r}^{′} ) = δ ( r - {r}^{′} ) , \qquad ( 81 )$$

which enables ψₗ(r) to be found via an integral over [symbol] ,

$$\begin{matrix}{ψ}_{l} ( r ) = \int {G}_{0} ( r , {r}^{′} ) {w}_{l} ( {r}^{′} ) {δ}_{𝒞} ( {r}^{′} ) {dr}^{′} \\ = {∮}_{𝒞} {G}_{0} ( r , {r}^{′} ) {w}_{l} ( {r}^{′} ) {dS}^{′}\end{matrix} . \qquad ( 82 )$$

The evaluation of (82) is simplest if [symbol] is parameterized. For a 2D domain, the 1D contour [symbol] can be specified as a vector function of the parameter t

$$χ ( t ) ≡ ( x ( t ) , y ( t ) ) , \qquad ( 83 )$$

as well as the weight, wₗ(t). Finally, ψₗ(r) can be obtained from

$${ψ}_{l} ( r ) = \int {G}_{0} ( r , χ ( t ) ) {w}_{l} ( t ) \vert \dot{χ} ( t ) \vert dt , \qquad ( 84 )$$

integrating over the appropriate range of t and using numerical quadrature if necessary. Note that |\dot{χ}(t)| represents the infinitesimal arc length. The numerical details of this procedure are presented later in the description. If [symbol] is composed of several piecewise smooth segments, then χ(t) can also be decomposed into n segments {χ₁(t), χ₂(t), . . . , χₙ(t)}, each specified over a different range of t, and (84) can be integrated segment by segment. Also, a decomposition of [symbol] is numerically expedient if [symbol] is well approximated by cubic splines.

Equation (79) defines a Poisson equation which, along with Dirichlet boundary conditions, yields a unique solution for each order 1. Since each mode Eₗ is inherently discontinuous, it is capable of replacing many hundreds or thousands of Fourier-Bessel basis modes (68), which suffer from slow convergence due to Gibbs phenomenon. An even more important consideration than efficiency is the numerical robustness of {ψₗ} for the solution of (22). Since there are much fewer degrees of freedom than in the Fourier-Bessel basis, this highly-constrained basis has limited freedom for generating numerical noise, greatly ameliorating numerical sensitivity issues. Also critical is that this basis entirely eliminates the problem of spurious modes, since by construction the modes have zero longitudinal component everywhere except the perturbation boundary.

One of the few disadvantages of boundary adapted longitudinal modes is that the resulting basis {ψₗ} is not in general orthogonal with respect to the inner product (19), thus an orthogonalization procedure is usually first necessary. Löwdin's method was employed, which is briefly summarized later.

The boundary adapted longitudinal modes are valid for all material parameters and wavelengths, and can even be adapted to inclusions that have both sharp and smooth spatial variations of permittivity. In comparison, the boundary element method requires the frequency and material parameters to be specified, and is applicable only to piecewise uniform structures. Thus, the boundary adapted longitudinal modes are more flexible and tends not to lead to nonlinear eigenvalue problems.

Numerical implementation are discussed later on in the description, beginning with normalization and perturbation integrals. Then, two methods of generating the boundary adapted longitudinal modes defined by (79) are presented. The first method is conceptually simple, and involves obtaining ψₗ using the Green's function for the Laplace operator and numerically integrating, described further in the description. This is a fast, accurate, and reliable method, but it involves some numerical intracies due to the divergence of the Green's function. It is suitable for implementation in production quality code. The second method involves expanding ψₗ using the Fourier-Bessel basis, described further in the description. Using the Fourier-Bessel basis to expand the boundary adapted longitudinal modes is much more numerically reliable than direct use of the Fourier-Bessel basis, and this fact is indirect proof of the strength of the boundary adapted basis. The expansion is numerically simple, but still suffers from low accuracy due to Gibbs phenomenon and slow speed due to the need to evaluate many integrals. Thus, it should only be used for testing and comparison purposes. An entirely numerical solution of (79) is possible, for example, via the finite element method. Indeed, this would constitute a simple application of the finite element method, and avoids the specialized techniques necessary for the Green's function approach, for example.

Normalization and perturbation integrals of boundary adapted longitudinal modes Another advantage of boundary adapted longitudinal modes is the simple numerical evaluation of normalization (19) and perturbation integrals (21). For normalization, consider the integral

$$\begin{matrix}{N}_{kl} ≡ \int {E}_{k}^{†} \cdot {E}_{l} dr = \int ∇ {ψ}_{k}^{†} \cdot ∇ {ψ}_{l} dr \\ = \int ∇ \cdot ( {ψ}_{k}^{†} ∇ {ψ}_{l} ) dr - \int {ψ}_{k}^{†} {∇}^{2} {ψ}_{l} dr \\ = {∮}_{𝒞} {ψ}_{k}^{†} ∇ {ψ}_{l} \cdot dS - \int {ψ}_{k}^{†} {w}_{l} {δ}_{𝒞} ( r ) dr \\ = - {∮}_{𝒞} {ψ}_{k}^{†} {w}_{l} dS\end{matrix} . \qquad ( 85 )$$

The surface integral after the third equality vanishes since all longitudinal modes are zero along the boundary by definition, while the final integral is due to the definition of δ [symbol] (r), (80). The final integral is compatible with standard numerical quadrature techniques. Due to the Dirac-delta function, the order of the integral is always reduced by one. The normalization integral is obtained for k=l, while the general case of k≠l yields modal overlaps.

The matrix of overlap integrals N calculated in (85) allows normalization and orthogonalization using Löwden's method, which treats all basis vectors equally and preserves any symmetry, unlike the Gram-Schmidt procedure. Despite its simplicity, it is usually only treated in the computational chemistry field and may not be commonly known, so a brief exposition is provide. It exploits the structure of N, which is Hermitian and positive definite, so long as the basis is linearly independent. The normalized longitudinal modes Dₘ are obtained by transforming the vectors by the matrix square root of N,

$${D}_{m} = {\sum }_{k} {E}_{k} {N}_{km}^{- \frac{1}{2}} . \qquad ( 86 )$$

An explicit computation demonstrates the desired properties,

$$\begin{matrix}\int {D}_{m}^{†} \cdot {D}_{n} dr = {\sum }_{k} {\sum }_{l} {N}_{km}^{* - \frac{1}{2}} {N}_{ln}^{- \frac{1}{2}} \int {E}_{k}^{†} \cdot {E}_{l} dr \\ = {\sum }_{k} {\sum }_{l} {N}_{km}^{* - \frac{1}{2}} {N}_{kl} {N}_{ln}^{- \frac{1}{2}} \\ = {δ}_{mn}\end{matrix} , \qquad ( 87 )$$

using the symmetry of

$${N}^{- \frac{1}{2}} ,$$

which is inherited from N.

(85) avoids treating the discontinuity in Eₗ, since the result involves ψₗ, which is everywhere continuous. This discontinuity is first evaluated at all points along the perturbation boundary. This can be derived directly from the defining equation (79) by integrating over an infinitesimal Gaussian pillbox that straddles the boundary,

$$\begin{matrix}\int {∇}^{2} {ψ}_{l} dr = \int {w}_{l} ( r ) {δ}_{𝒞} ( r ) dr \\ ∮ ∇ {ψ}_{l} \cdot dn = \int {w}_{l} ( r ) dS \\ \int ( ∇ {ψ}_{l}^{+} - ∇ {ψ}_{l}^{-} ) \cdot \hat{n} dS = \int {w}_{l} ( r ) dS \\ ( {E}_{l}^{+} - {E}_{l}^{-} ) \cdot \hat{n} = {w}_{l} ( r )\end{matrix} \qquad ( 88 )$$

where Eₗ⁺−Eₗ⁻ is the difference ΔEₗ across the boundary, and \hat{n} is the unit vector normal to the interface. Therefore, the magnitude of the discontinuity is given by the magnitude of the Dirac-delta function. As for the parallel component of Eₗ, the intuitive result that its discontinuity is zero can be derived using similar arguments starting from the identity

$$∇ \times ∇ {ψ}_{l} = 0. \qquad ( 89 )$$

the matrix element (21) is now treated,

$$\begin{matrix}{V}_{kl} ≡ \int {E}_{k}^{†} \cdot Δθ ( r ) {E}_{l} dr = \int ∇ {ψ}_{k}^{†} \cdot ∇ {ψ}_{l} dr \\ = \int ∇ \cdot ( {ψ}_{k}^{†} ∇ {ψ}_{l} ) dr - \int {ψ}_{k}^{†} {∇}^{2} {ψ}_{l} dr \\ = {∮}_{𝒞} {ψ}_{k}^{†} {E}_{l} \cdot dS\end{matrix} , \qquad ( 90 )$$

where the surface integral is now along the interior boundary of Δθ(r). This time, the integral involving ∇²ψₗ, vanishes, since ∇²ψₗ=0 within the region Δθ(r), which is an open set. This means there is a need to evaluate the integral along the interior boundary of the perturbation so Eₗ by Eₗ⁻ are being replaced. Then by invoking (88), a particularly convenient result follows,

$$\begin{matrix}{V}_{kl} = {∮}_{𝒞} {ψ}_{k}^{†} ( {E}_{l} ave - \frac{Δ {E}_{l}}{2} ) \cdot dS \\ = {∮}_{𝒞} {ψ}_{k}^{†} {E}_{l} ave \cdot dS - \frac{1}{2} {∮}_{𝒞} {ψ}_{k}^{†} {w}_{l} dS\end{matrix} , \qquad ( 91 )$$

where

$${E}_{l} ave = \frac{1}{2} ( {E}_{l}^{+} + {E}_{l}^{-} )$$

is the sum of the two discontinuous fields. It will be shown now that an efficient technique for obtaining Eₗave exists in the following parts of the description. Conveniently, the second term in (91) is precisely the overlap integral obtained in (85).

### Fourier-Bessel Expansion of Boundary Adapted Longitudinal Modes

The Fourier-Bessel basis is used to expand (79),

$${ψ}_{l} = {\sum }_{n , m} {c}_{mn} {ϕ}_{mn} . \qquad ( 92 )$$

The coefficients can be evaluated via expansion and projection,

$$\begin{matrix}{\sum }_{n , m} {c}_{mn} {∇}^{2} {ϕ}_{mn} = {∇}^{2} {ψ}_{l} \\ - {\sum }_{n , m} {c}_{mn} {α}_{mn}^{2} {ϕ}_{mn} = {w}_{l} ( r ) {δ}_{𝒞} ( r ) \\ - {\sum }_{n , m} {c}_{mn} {α}_{mn}^{2} \int {ϕ}_{kl}^{†} {ϕ}_{mn} dr = \int {ϕ}_{kl}^{†} {w}_{l} ( r ) {δ}_{𝒞} ( r ) dr \\ {c}_{mn} = - {∮}_{𝒞} {w}_{l} {ϕ}_{mn}^{†} dS\end{matrix} \qquad ( 93 )$$

where the overlap integral between modes was evaluated using (72) assuming the normalization (19). A similar derivation can be performed for the adjoint modes ψₗ^{†}, obtaining expansion coefficients cₘₙ^{†}.

Normalization of ψₗ is simple if the basis ϕₘₙ is already normalized. Instead of (85), the integral can be obtained from a simple sum,

$$\begin{matrix}\int ∇ {ψ}_{l}^{†} \cdot ∇ {ψ}_{l} dr = {\sum }_{kl} {\sum }_{mn} {c}_{kl}^{†} {c}_{mn} \int ∇ {ϕ}_{kl}^{†} \cdot ∇ {ϕ}_{mn} dr \\ = {\sum }_{mn} {c}_{mn}^{†} {c}_{mn}\end{matrix} . \qquad ( 94 )$$

If desired, the integrals of the matrix elements (21) involving ψₗ can also be evaluated in the basis of ϕₘₙ, for example

$$\int ∇ {ψ}_{l}^{†} \cdot Δθ ( r ) ∇ {ψ}_{t} dr = {\sum }_{k , l} {\sum }_{n , m} {c}_{kl}^{†} {c}_{mn} \int ∇ {ϕ}_{kl}^{†} \cdot Δθ ( r ) ∇ {ϕ}_{mn} dr . \qquad ( 95 )$$

Expanding boundary adapted longitudinal modes using the Fourier-Bessel has some disadvantages. Firstly, the resulting boundary adapted longitudinal modes are susceptible to Gibbs phenomenon. This limits the accuracy of the matrix elements (95), and ultimately the accuracy of the perturbed modes \tilde{E}_{μ}. One possible visible manifestation of this inaccuracy is a “halo” in the \tilde{E}_{μ} field at r=B, the basis boundary. This halo is a numerical artifact resulting from incorrect contributions among the various {ψₗ}. Better methods exist for finding the boundary adapted longitudinal modes.

### Green's Function Solution of Boundary Adapted Longitudinal Modes

Further details of evaluating (79) are now supplied, directly using the Green's function for the Laplace operator, (81). In particular, the explicit form of the 2D Green's function when subject to the Dirichlet boundary condition G_{D}(r=B,r′)=0 can be found by the method of images,

$${G}_{D} ( r , {r}^{′} ) = \frac{1}{4 π} log ( \frac{{\vert r - r ′ \vert}^{2} {B}^{2}}{{\vert r - r ″ \vert}^{2} r {′}^{2}} ) , \qquad ( 96 )$$

where r′ is the location of the source and r″ is the location of the image source,

$${r}^{″} = \frac{{B}^{2}}{r {′}^{2}} {r}^{′} . \qquad ( 97 )$$

To obtain ψₗ, integration is being performed over all source terms, as in (82).

The evaluation of Eₗ(r) is also necessary, for the matrix elements (90), for example.

The gradient of G_{D}(r,r′) is thus derived. To simplify the notation, the following two vectors are introduced

$${R}^{′} ≡ r - {r}^{′} , {R}^{″} ≡ r - {r}^{″} . \qquad ( 98 )$$

By chain rule, the following is obtained

$$\begin{matrix}∇ {G}_{D} ( r , {r}^{′} ) = {\partial }_{R ′} {G}_{D} ( r , {r}^{′} ) ∇ {R}^{′} + {\partial }_{R ″} {G}_{D} ( r , {r}^{′} ) ∇ {R}^{″} \\ = \frac{1}{2 π} [ \frac{r - r ′}{{\vert r - r ′ \vert}^{2}} - \frac{r - r ″}{{\vert r - r ″ \vert}^{2}} ]\end{matrix} , \qquad ( 99 )$$

$$since$$

$${\partial }_{R ′} {G}_{D} ( r , {r}^{′} ) = \frac{1}{R ′} , ∇ {R}^{′} = \frac{R ′}{R ′} . \qquad ( 100 )$$

Correspondingly,

$${E}_{l} ( r ) = ∇ {ψ}_{l} ( r ) = {∮}_{𝒞} ∇ {G}_{D} ( r , {r}^{′} ) {w}_{l} ( {r}^{′} ) {dS}^{′} . \qquad ( 101 )$$

In principle, (82) and (101) are sufficient to obtain the modes and perform all necessary integrals, but in practice, their evaluation is often problematic if attempted using naive methods. Difficulties arise if r sits on the perturbation boundary, such that r and r′ coincide, since the Green's function kernel (96) has a logarithmic singularity. Yet, it is vital to obtain ψₗ and Eₗ along the perturbation boundary, as the most efficient methods for evaluating integrals such as (85) rely on these values. Fortunately, efficient and reliable quadrature methods exist for the evaluation integrable singularities. Meanwhile, (99) has a simple pole singularity, so (101) is not integrable and can only defined in the Cauchy principal value sense. One might then wonder whether or not (101) yields a physical quantity. Actually, the Cauchy principal value represents the average of the two discontinuous values across the boundary E ave(r), required for evaluating (91). This result is a consequence of the Plemelj formula. Furthermore, since the difference is also known from (88), the individual values E⁺ and E⁻ can be deduced. Efficient and reliable numerical evaluation of these integrals is treated in later in the description.

Finally, the winding number of a closed curve [symbol] around a point r′ is introduced, which is useful for distinguishing whether r′ is interior or exterior. While this quantity is not essential for numerical implementation, it is of great aid for sanity checks. It can be expressed as

$$W = \frac{1}{2 π} {∮}_{𝒞} d ϑ = \frac{1}{2 π} {∮}_{𝒞} \frac{r - r ′}{{\vert r - r ′ \vert}^{2}} \cdot d \hat{n} , \qquad ( 102 )$$

where ϑ is the angle between r−r′ and some reference vector, such as \hat{x}. The obvious similarity to (99) hints at the deep underlying connection. The winding number is applicable to any curve, though simpler, faster criteria are available for simpler curves.

### Numerical Quadrature and Singular Integrands

Numerical quadrature and singular integrands treats the quadrature techniques for singular integrals along 1D intervals. Evaluation is simplest if a parameterization χ(t) of the interface is known, as given by (83), and furthermore, if this parameterization is regular. This reduces (82) and other relevant integrals to 1D integrals along t in the form of (84), for example. Three quadrature techniques are presented, leading to three types of integrands: smooth functions without singularities, functions with logarithmic singularities, and Cauchy principle value integrals. All are variations of Gaussian quadrature, which are among the most efficient techniques.

As a preliminary step, all integrals along the curve [symbol] are converted to an integral in t. This was done for (84), and for a general scalar integrand one has

$${\int }_{𝒞} f ( r ) ds = \int f ( χ ( t ) ) \vert \dot{χ} ( t ) \vert dt . \qquad ( 103 )$$

Meanwhile, a surface integral of the form (90) becomes

$${\int }_{𝒞} f ( r ) \cdot d \hat{n} = \int f ( χ ( t ) ) \cdot ( \dot{χ} ( t ) \times \hat{z} ) dt , \qquad ( 104 )$$

where \hat{n} is outward normal to the curve and \hat{z} is normal to the plane of the curve. d\hat{n}=\dot{χ}(t)×\hat{z} dt is obtained for a positively oriented curve because \dot{χ}(t) is always tangential to a normally parameterized curve χ(t). These integrals are readily evaluated by Gaussian quadrature if the integrands are nowhere singular, so

$${\int }_{- 1}^{1} f ( t ) dt = {\sum }_{n = 1}^{N} {w}_{n} f ( {t}_{n} ) , \qquad ( 105 )$$

where tₙ is the nth root of the Legendre polynomial P_{N}(t) and the weights wₙ are

$${w}_{n} = \frac{2}{( 1 - {t}_{n}^{2} ) {( P {′}_{N} ( {t}_{n} ) )}^{2}} . \qquad ( 106 )$$

For the Cauchy principal value integral of (101), with a singularity at t=t′ that lies within the domain of integration, a modified Gaussian quadrature rule exists,

$$0 = - \int - 00 = - \int - 00 = - \int - 00 = - \int - 0 \\ {\int }_{- 1}^{1} \frac{f ( t )}{t - t ′} dt \approx - \frac{2 f ( t ′ ) {Q}_{N} ( t ′ )}{{P}_{N} ( t ′ )} + {\sum }_{n = 1}^{N} \frac{{v}_{n} f ( {t}_{n} )}{{t}_{n} - t ′} , \qquad ( 107 )$$

where Q_{N}(x) is the Legendre function of the second kind, and the weight functions are now

$${v}_{n} = - \frac{2}{( N + 1 ) P {′}_{N} ( {t}_{n} ) {P}_{N + 1} ( {t}_{n} )} . \qquad ( 108 )$$

f(t′) may be viewed as the residue of the function g(t)≡f(t)/(t−t′) at t=t′.

For the integration of (101), this residue may be found via series expansion. It is sufficient to consider only the singular term (r−r′)/|r−r′|², since the non-singular term (r−r″)/|r−r″|² can be efficiently integrated by standard Gaussian quadrature. Using the expansion χ(t)=χ(t′)+\dot{χ}(t′)(t−t′)+\ddot{χ}(t′)(t−t′)²/2+ . . . , the following is obtained

$$\frac{χ ( t ) - χ ( {t}^{′} )}{{\vert χ ( t ) - χ ( {t}^{′} ) \vert}^{2}} \approx \frac{\dot{χ} ( {t}^{′} )}{{\vert \dot{χ} ( {t}^{′} ) \vert}^{2}} \frac{1}{t - {t}^{′}} , \qquad ( 109 )$$

where higher orders terms in (t−t′) have been neglected. This is always possible since \dot{χ}(t) is never zero for a regular parameterization of a curve. Thus, the integration of the singular part of (99) over some segment [symbol] proceeds by inserting into (103) and (107) to yield

$${\int }_{𝒞} \frac{r - {r}^{′}}{{\vert r - {r}^{′} \vert}^{2}} {ds}^{′} \approx 2 \frac{\dot{χ} ( t )}{\vert \dot{χ} ( t ) \vert} \frac{{Q}_{N} ( t )}{{P}_{N} ( t )} + {\sum }_{n = 1}^{N} {v}_{n} \frac{χ ( t ) - χ ( {t}_{n} )}{{\vert χ ( t ) - χ ( {t}_{n} ) \vert}^{2}} \vert \dot{χ} ( {t}_{n} ) \vert , \qquad ( 110 )$$

where χ(t′) is parameterization of [symbol] extending from t′=−1 to 1 and χ(t) is the detector point located on [symbol] .

A modified Gaussian quadrature rule also exists for integrands with a logarithmic singularity at an endpoint of the integration interval. In our case, the logarithmic singularity is usually within the integration interval, so the interval must first be split into two segments on which the quadrature rule is separately applied. Unlike the above quadrature rules, closed form expressions for the weights and nodes are no longer available, and they must be obtained via a numerical procedure. Fortunately, values have already been computed and available in the literature, so there is no need to perform this numerical procedure.

### Evaluation of Perturbation Integrals

Once all basis modes have been prepared, including the transverse modes and longitudinal modes, the matrix elements of (21),

$$\int {E}_{s}^{†} \cdot {E}_{t} Δ θ ( r ) dr , \qquad ( 111 )$$

are ready to be evaluated. These integrals over the perturbation typically require numerical integration which can be computationally intensive, especially for higher-order modes with high spatial frequencies. To reduce the computational burden, it is possible to use vector identities to reduce the order of integration by one for piecewise uniform perturbations. This technique was already utilized in (90), for example. Such techniques were unnecessary in previous implementations of the perturbation method because only cases where the integrals could be calculated analytically were considered.

The simplest case to consider is the integral between transverse modes and longitudinal modes. Let Eₛ be the longitudinal mode and Eₜ the transverse. Firstly, the electric field Eₜ of the transverse mode is expressed in terms of its magnetic field using the Maxwell curl equation (55), while the longitudinal mode is Eₛ=∇ϕₛ. Since Δθ(r) is assumed to be a piecewise uniform function, one may decompose the domain of integration into one or more disjoint subdomains that is considered separately, and apply the vector identity

$$\begin{matrix}\int {E}_{s}^{†} \cdot ∇ \times {H}_{t} d r = \int ∇ \cdot ( {H}_{t} \times ∇ {ϕ}_{s}^{†} ) d r + \int {H}_{t} \cdot ∇ \times ∇ {ϕ}_{s}^{†} d r \\ = ∮ ( {H}_{t} \times {E}_{s}^{†} ) \cdot dn\end{matrix} . \qquad ( 112 )$$

This integral is simple to treat because the second term on the RHS of (112) is identically zero.

For 2D geometries, the integral can be split into two cases and be further simplified. If the transverse field is of TM polarization, then its in-plane electric field components E_{⊥} are zero, while the only nonzero electric field components of longitudinal modes are in-plane. Thus, these integrals are always identically zero. If the transverse field is of TE polarization, then H=H_{z}\hat{z}, so

$$\begin{matrix}∮ ( {H}_{z , t} \hat{z} \times {E}_{s}^{†} ) \cdot dn = - ∮ ( {H}_{z , t} \hat{z} \times {E}_{s}^{†} ) \cdot \hat{z} \times d s \\ = - ∮ {H}_{z , t} {E}_{s}^{†} \cdot ds\end{matrix} . \qquad ( 113 )$$

The E fields of longitudinal modes are discontinuous, but their tangential component is continuous, so no special techniques are necessary for this integral.

Now the proposed method turns to the integrals between transverse modes, which require more manipulation to mould into the required form. To simplify the manipulations, the 2D case is specifically treated. Firstly, if Eₛ^{†} is a TM mode and Eₜ is a TE mode, then Eₛ^{†}·Eₜ is identically zero, since they do not share any common nonzero elements. Next, if both modes are TM, then both modes have the form E=E_{z}\hat{z}. To begin the process, consider the vector identity

$$\begin{matrix}∇ \cdot ( {E}_{z , s}^{↑} ∇ {E}_{z , t} ) = {E}_{z , s}^{↑} {∇}^{2} {E}_{z , t} + ∇ {E}_{z , s}^{†} \cdot ∇ {E}_{z , t} \\ = {α}_{t}^{2} {E}_{z , s}^{†} {E}_{z , t} + ∇ {E}_{z , s}^{†} \cdot ∇ {E}_{z , t}\end{matrix} , \qquad ( 114 )$$

which holds because the basis modes (7) satisfy the Helmholtz equation

$${∇}^{2} {E}_{m} + {α}_{m}^{2} {E}_{m} = 0 , \qquad ( 115 )$$

inside the inclusion, where αₘ²=k²ϵₘ. The second term of on the Right Hand Side (RHS) of (114) is unwanted, and can be eliminated by subtracting from a second identity, obtained by conjugating and the exchange of s and t,

$$∇ \cdot ( {E}_{z , t} ∇ {E}_{z , s}^{†} ) = {α}_{s}^{2} {E}_{z , s}^{†} {E}_{z , t} + ∇ {E}_{z , s}^{†} \cdot ∇ {E}_{z , t} , \qquad ( 116 )$$

to give

$${E}_{z , s}^{†} {E}_{z , t} = \frac{∇ \cdot ( {E}_{z , s}^{†} ∇ {E}_{z , t} ) - ∇ \cdot ( {E}_{z , t} ∇ {E}_{z , s}^{†} )}{{α}_{t}^{2} - {α}_{s}^{2}} . \qquad ( 117 )$$

Finally, the contour integral representation was obtained successfully,

$$\int {E}_{z , s}^{†} {E}_{z , t} d A = \frac{1}{{α}_{t}^{2} - {α}_{s}^{2}} [ ∮ ( {E}_{z , s}^{†} ∇ {E}_{z , t} ) \cdot dn - ∮ ( {E}_{z , t} ∇ {E}_{z , s}^{†} ) \cdot dn ] . \qquad ( 118 )$$

consider the case where both Eₛ^{†} and Eₜ are TE modes, and can be represented as (55). Then, consider the vector identity

$$\begin{matrix}∇ \cdot ( {H}_{s}^{†} \hat{z} \times ( ∇ \times ( {H}_{t} \hat{z} ) ) ) & = & ∇ \times ( {H}_{s}^{†} \hat{z} ) \cdot ∇ \times ( {H}_{t} \hat{z} ) - {H}_{s}^{†} \hat{z} ∇ \times \\ & & ( ∇ \times ( {H}_{t} \hat{z} ) ) \\ ∇ \cdot ( {H}_{s}^{†} \hat{z} \cdot \hat{z} ∇ {H}_{t} - {H}_{s}^{†} \hat{z} ( \hat{z} \cdot ∇ ) {H}_{t} ) & = & ∇ \times ( {H}_{s}^{†} \hat{z} ) \cdot ∇ \times ( {H}_{t} \hat{z} ) - {α}_{t}^{2} {H}_{s}^{†} {H}_{t} \\ ∇ \cdot ( {H}_{s}^{†} ∇ {H}_{t} ) & = & ∇ \times ( {H}_{s}^{†} \hat{z} ) \cdot ∇ \times ( {H}_{t} \hat{z} ) - {α}_{t}^{2} {H}_{s}^{†} {H}_{t}\end{matrix} . \qquad ( 119 )$$

Now, the second term on the RHS is unwanted, so it was again subtracted from a second identity obtained by conjugating and switching subscripts. This yields

$$∇ \times ( {H}_{s}^{†} \hat{z} ) \cdot ∇ \times ( {H}_{t} \hat{z} ) = \frac{{α}_{s}^{2} ∇ \cdot ( {H}_{s}^{†} ∇ {H}_{t} ) - {α}_{t}^{2} ∇ \cdot ( {H}_{t} ∇ {H}_{s}^{†} )}{{α}_{s}^{2} - {α}_{t}^{2}} , \qquad ( 120 )$$

and the integral ∫Eₛ^{†}·Eₜ dA follows accordingly.

The identities (117) and (120) become indeterminate for the case Eₛ=Eₜ, or more generally when αₛ²=αₜ², since both the numerator and denominator approach zero. This applies to the diagonal matrix elements of (21) and a small number of off-diagonal elements. A well defined value can nevertheless still be obtained in the limit of small ε where αₜ=αₛ+ε. To evaluate this limit, an expansion of the perturbed fields E_{t+ε}≡Eₛ was required for small ε. This is easier to compute if the function form of Eₜ is known, which one shall assume to be a Bessel function multiplied by a cylindrical harmonic. Then, perturbing the propagation constant αₜ of the mode only changes the radial dependence, obtained via Taylor expansion

$${J}_{m} ( α r + ε r ) \approx {J}_{m} ( α r ) + {J}_{m}^{′} ( αr ) εr + … . \qquad ( 121 )$$

The first order expansion of E_{t+ε} was thus obtained,

$${E}_{t + ε} \approx {E}_{t} + {E}_{t}^{′} ε r + … . \qquad ( 122 )$$

(117) was proceed to be evaluated in the limit ε→0, ignoring all terms of order ε² and higher

$$\begin{matrix}{\int }_{P} ∇ {ϕ}_{m}^{†} \cdot ∇ {ϕ}_{n} dr = \frac{1}{{α}_{m}^{2} - {( {α}_{m} + ε )}^{2}} {∮}_{\partial P} [ {α}_{m}^{2} {ϕ}_{m}^{†} ∇ {ϕ}_{n + ε} - ( {α}_{m} + \\ {ε )}^{2} {ϕ}_{n + ε} ∇ {ϕ}_{m}^{†} ] \cdot dS \\ = \frac{- 1}{2 {α}_{m} ε} {∮}_{\partial P} [ {α}_{m}^{2} {ϕ}_{m}^{†} ∇ ( {ϕ}_{n} + {ϕ}_{n}^{′} ε r ) - {α}_{m}^{2} ( {ϕ}_{n} + \\ {ϕ}_{n}^{′} ε r ) ∇ {ϕ}_{m}^{†} - 2 {α}_{m} ε {ϕ}_{n} ∇ {ϕ}_{m}^{†} ] \cdot dS \\ = \frac{1}{2} {∮}_{\partial P} [ 2 {ϕ}_{n} ∇ {ϕ}_{m}^{†} + {α}_{m} ( r {ϕ}_{n}^{′} ∇ {ϕ}_{m}^{†} - {ϕ}_{m}^{†} ∇ ( r {ϕ}_{n}^{′} ) ) ] \cdot dS\end{matrix} \qquad ( 123 )$$

FIG. 2 is a flowchart of the fast solution of partial differential equations using a modal approach, according to an embodiment of the invention. At the first step 201, the background geometry and the scatterers geometry are defined. At the next step 202, each scatterer is embedded in a simpler geometry (see FIG. 1). At the next step 203, the base transverse modes are calculated for each embedding geometry (see 0099). At the next step 204, longitudinal modes are calculated for each scatterer (see 00117). At the next step 205, the overlap matrix (Eq. (20) or equivalently, (22)) is calculated for each scatterer and the resulting eigenvalue equation is solved for each scatterer, using the base transverse modes that have been calculated for each embedding geometry and the longitudinal modes that have been calculated for each scatterer. At the next step 206, the modes of each pair of scatterers are computed via the hybridization technique described in [Rosolen, Chen, Maes, Sivan, Phys. Rev. B 101, 155401 (2020)]. Specifically, the modes of each pair are computed by computing the overlap of each mode of one scatterer with each mode of the second scatterer, and solving the resulting eigenvalue equation. At the next step 207, the resulting eigenvalue equation are solved for the complete structure At the next step 208, the source is projected on target modes and the result is substituted in the final equation (Eq. (10)).

The invention proposes a robust, accurate and fast numerical method to compute generalized electromagnetic modes (monochromatic source free solutions of the Maxwell's equations) with permittivity eigenvalues with a longitudinal polarization for an arbitrary complex structure. The proposed method allows to overcome all the limitations of previous attempts to provide a simple and numerically reliable modal expansion for Maxwell's equations. The method is applicable, to the solution of any partial differential equation, thus, it is applicable in a diverse range of applications, such the design of consumer product such as ovens, cars, airplanes; electronic, magnetic and optical devices; building design and stress/strain analysis; gas and fluid flow; computer graphics for gaming, clothing, artistic applications and many more.

The invention is highly efficient computational method based on an unusual modal expansion in terms of (complex) eigen-permittivity normal. The eigen-permittivity is the permittivity value for which the scattering structure (e.g., an antenna array) is at resonance; The eigen-functions (also known as Normal modes) are stationary solutions of Maxwell's equations which characterize the possible field distributions in a given structure (regardless of a specific illumination/radiation pattern).

For a fixed (real) frequency, the method allows obtaining the field distribution everywhere in space for an arbitrarily complex structure for arbitrary-shaped (continuous wave) illumination in a single simulation. This is a new possibility that emerges as a highly-efficient alternative to “brute force” numerical characterization of antenna arrays, while being orders of magnitude faster. In addition, it overcomes all the problems associated with the well-known modal expansion methods based on complex eigen-frequencies. The proposed method is exact (complete) everywhere in space, for ensuring convergence to the correct solution.

The completeness of the proposed method allows expanding the modes of the complex object in terms of known modes of an embedding simple shape (e.g., a slab in 1D, circle in 2D and sphere in 3D). The expansion coefficients are calculated as overlap integrals of the latter modes over the complex object.

As various embodiments have been described and illustrated, it should be understood that variations will be apparent to one skilled in the art without departing from the principles herein. Accordingly, the invention is not to be limited to the specific embodiments described and illustrated in the drawings.

### REFERENCES

[1] R. M. Hestenes and E. Stiefel. Methods of conjugate gradients for solving linear systems. Journal of Research of the National Bureau of Standards, 49:409, 1952.
[2] K. N. Reddy, P. Y. Chen, A. I. Fernandez-Dominguez, and Y. Sivan. Surface second-harmonic from metallic nanoparticle configurations—a transformation optics approach. JOSAB 34, 1824-1832 (2017).
[3] W. H. Press, B. P. Flannery, S. A. Teukolsky, and W. T. Vetterling. Numerical recipes in C: The Art of Scientific Computing. Cambridge, 1988.
[4] L. Novotny and B. Hecht. Principles of nano-optics. Cambridge University Press, 2006.
[5] D. M. Solis, J. M. Taboada, F. Obelleiro, L. M. Liz-Marzán, and F. Javier Garcia de Abajo. Toward ultimate nanoplasmonics modeling. ACS Nano, 8:7559U7570, 2014.”
[6] S. Molesky, Z. Lin, A. Y. Piggott, W. Jin, J. Vucković, and A. W. Rodriguez. Inverse design in nanophotonics. Nature Photonics, 12:659U670, 2018.
[7] P. Lalanne, W. Yan, K. Vynck, C. Sauvan, and J.-P. Hugonin. Light interaction with photonic and plasmonic resonances. ArXiv:170502433 Phys., 2017.
[8] W. Yan, R. Faggiani, and P. Lalanne. Rigorous modal analysis of plasmonic nanoresonators. Phys. Rev. B, 205422, 2018.
[9] G. Demésy, A. Nicolet, B. Gralak, C. Geuzaine, C. Campos, and J. E. Roman. Nonlinear eigenvalue problems with getdp and slepc: Eigenmode computations of frequency-dispersive photonic open structures. ArXiv, https://arxiv.org/pdf/1802.02363.pdf, 2018.
[10] M. B. Doost, W. Langbein, and E. A. Muljarov. Resonant-state expansion applied to threedimensional open optical systems. Phys. Rev. A, 90:013834, 2014.
[11] R.-C. Ge, P. T. Kristensen, J. F. Young, and S. Hughes. Quasinormal mode approach to modelling light-emission and propagation in nanoplasmonics. New J. Phys., 16:113048, 2014.
[12] R. F. Harrington, J. R. Mautz, and Y. Chang. Characteristic modes for dielectric and magnetic bodies. IEEE Trans. Ant. Prop., AP-20:194, 1972.
[13] Q. Bai, M. Perrin, C. Sauvan, J-P Hugonin, and P. Lalanne. Efficient and intuitive method for the analysis of light scattering by a resonant nanostructure. Opt. Express, 21(22):27371, 2013.
[14] D. J. Bergman and D. Stroud. in Solid State Physics, H. Ehrenreich and D. Turnbull, eds., Vol. 46, pp. 148-270. Academic Press, 1992.
[15] M. S. Agranovich, B. Z. Katsenelenbaum, A. N. Sivov, and N. N. Voitovich. Generalized method of eigenoscillations in diffraction theory. Wiley-VCH, 1999.
[16] P. Y. Chen, D. J. Bergman, and Y. Sivan. Generalizing normal mode expansion of electromagnetic Green's tensor to lossy resonators in open systems. Phys. Rev. Applied, 11:044018, 2019.
[17] A. Farhi and D. Bergman. Electromagnetic eigenstates and the field of an oscillating point electric dipole in a flat-slab composite structure. Phys. Rev. A, 93:063844, 2016.
[18] D. J. Bergman and D. Stroud. Theory of resonances in the electromagnetic scattering by macroscopic bodies. Phys. Rev. B, 22:3527-3539, 1980.
[19] C. Cohen-Tanoudji, B. Diu, and F. Laloë. Quantum Mechanics. John Wiley & sons, 1977.
[20] H. Koegelnik. Coupled wave theory for thick hologram gratings. Bell Sys. Techn. J., 48:2909, 1969.
[21] A. Yariv and P. Yeh. Photonics. Oxford University Press, 6th edition, 2007.
[22] H. A. Haus. Waves and Fields in Optoelectronics. Prentice Hall, Englewood Cliffs, N.J., 1984.
[23] S. L. Chuang. A coupled mode formulation by reciprocity and a variational principle. J. Lightwave Tech., LT-5:1222, 1987.
[24] W. Streifer, M. Osinski, and A. A. Hardy. Reformulation of the coupled-mode theory of multiwaveguide systems. J. Lightwave Tech., LT-5:1-4, 1987.
[25] H. A. Haus, W. P. Huang, and A. W. Snyder. Coupled-mode formulations. Opt. Lett., 14:1222, 1989.
[26] S. E. Kocabas, G. Veronis, D. A. B. Miller, and S. Fan. Modal analysis and coupling in metal-insulator-metal waveguides. Phys. Rev. B, 79:035120, 2009.
[27] K. Okamoto. Fundamentals of Optical waveguides. Academic Press, 2nd edition, 2006.
[28] A. W. Snyder and J. Love. Optical Waveguide Theory. Springer, New York, 1983.
[29] P. Y. Chen and Y. Sivan. Robust location of optical fiber modes via the argument principle method. Computer Physics Communications, 214:105-116, 2017.
[30] J. Jn. The Finite Element Method in electromagnetism. J. Wiley & sons, 2nd edition, 2002.
[31] [Rosolen, Chen, Maes, Sivan: “Overcoming the bottleneck for quantum computations of complex nanophotonic structures: Purcell and Förster resonant energy transfer calculations using a rigorous mode-hybridization method”, Phys. Rev. B 101, 155401 (2020)]

1. A method for providing fast and efficient solution of partial differential equations to calculate the permittivity modes of an arbitrarily complex scatterer geometry using a modal approach, comprising:
a) defining the background geometry and the scatterer's geometry;
b) embedding each scatterer in a simpler geometry;
c) calculating the base transverse modes for each embedding geometry;
d) for each scatterer:
calculating the longitudinal modes;
calculating the overlap matrix;
solving and the resulting eigenvalue equation, using the base transverse modes that have been calculated for each embedding geometry and the longitudinal modes that have been calculated for said each scatterer;
e) if there is more than one scatterer, hybridizing the modes of each pair of scatterers, otherwise,
f) solving the resulting eigenvalue equation for the complete structure;
g) projecting the source is on target modes; and
h) substituting the result is in the final equation.

2. A method according to claim 1, wherein a limited set of overlap integrals between the modes of an embedding simple shape are computed, for allowing solving a smaller eigenvalue equation for the modes.

3. A method according to claim 1, wherein the modes of an arbitrarily complex scatterer embedded inside a bigger scatterer of a simple shape are expanded, using the completeness of the permittivity modes inside said scatterer.

4. A method according to claim 1, wherein the eigenvalues of the simpler shapes are computed using an algebraic equation.

5. A method according to claim 1, wherein the entries in the eigenvalue equation are overlap integrals of the known modes over the domain of an arbitrary scatterer.

6. A method according to claim 1, wherein the calculation of modes incorporates naturally the mode discontinuity at the scatterer boundary, for minimizing the size of the eigenvalue problem that has to be solved.

7. A method according to claim 2, wherein the overlap integrals are evaluated by replacing the volume integrals by surface integrals and the surface integrals by line integrals.

8. A method according to claim 1, wherein modes of the target geometry are expanded based on the modes of a simpler geometry.

9. A system for providing fast and efficient solution of partial differential equations to calculate the permittivity modes of an arbitrarily complex scatterer geometry using a modal approach, comprising at least one processor, adapted to:
a) define the background geometry and the scatterer's geometry;
b) embed each scatterer in a simpler geometry;
c) calculate the base transverse modes for each embedding geometry;
d) for each scatterer:
calculate the longitudinal modes;
calculate the overlap matrix;
solve and the resulting eigenvalue equation, using the base transverse modes that have been calculated for each embedding geometry and the longitudinal modes that have been calculated for said each scatterer;
e) hybridize the modes of each pair of scatterers if there is more than one scatterer, otherwise,
f) solve the resulting eigenvalue equation for the complete structure;
g) project the source is on target modes; and
h) substitute the result is in the final equation.

10. A system according to claim 9, in which modes of the target geometry are expanded based on the modes of a simpler geometry.

11. A system according to claim 9, in which the calculation of modes incorporates naturally the mode discontinuity at the scatterer boundary being boundary-adapted modes, for minimizing the size of the eigenvalue problem that has to be solved.
